(19) United States
(12) Patent Application Publication
(10) Pub. No.: US 2008/0113764 A1
(43) Pub. Date: May 15, 2008

(54) SYSTEM, METHOD AND APPARATUS TO PRODUCE DECKS FOR AND OPERATE GAMES PLAYED WITH PLAYING CARDS

(76) Inventor: Richard Soltys, Mercer Island, WA (US)

Correspondence Address: SEED INTELLECTUAL PROPERTY LAW GROUP, PLLC, 701 FIFTH AVENUE, SUITE 5400, SEATTLE, WA, 98104, US

(21) Appl. No.: 11/558,409

(22) Filed: Nov. 9, 2006

(51) Int. Cl. G06F 17/00

(52) U.S. Cl. 463/22; 463/42

(57) ABSTRACT

A composition of a set of playing cards employing a plurality of standard playing cards and bonus playing cards may be determined, resulting in a desired theoretical hold or advantage for the gaming establishment. The composition identifies the number of each of a variety of bonus playing cards to include in a set of playing cards to achieve the theoretical hold. The composition may be based on a desired theoretical hold, rule(s), and/or bonus parameters.

### BACKGROUND OF THE INVENTION

1. Field of the Invention

This description generally relates to the field of table gaming and, more particularly, to games played with playing cards.

2. Description of the Related Art

There are numerous games played with playing cards. For example, blackjack, baccarat, various types of poker, LET IT RIDE®, and/or UNO®, to name a few. Games may be played with one or more standard decks of playing cards. A standard deck of playing cards typically comprises fifty-two playing cards, each playing card having a combination of a rank symbol and a suit symbol, selected from thirteen rank symbols (i.e., 2, 3, 4, 5, 6, 7, 8, 9, 10, J, Q, K, and A) and four suit symbols (i.e., ♡, [symbol] , ♦, and [symbol] ). Some games may employ sets of playing cards including a fewer or a greater number of playing cards than those comprising a standard deck. Some games may include non-standard playing cards, for example playing cards with symbols other than the rank and suit symbols associated with a standard deck.

In some instances playing card games involve wagering, where money and/or prizes may be won. In other instances playing card games are played without wagering, for fun or recreation. In either case, it is typically desirable to randomize the set of playing cards before dealing the playing cards to the participants (e.g., players and/or dealer). Randomizing is typically referred to as shuffling, which describes the act of riffling or interleaving the corners of two stacks of playing cards by hand.

In other instances, it may be useful to arrange or otherwise sort playing cards into a defined order. For example, it may be desirable to form sorted packs or decks of playing cards after the playing cards are collected from one or more gaming tables in a casino. The packs or decks can then be checked for completeness, and reused, or sold.

Numerous devices and systems have been developed for automatically randomizing or sorting playing cards. One approach attempts to mechanically replicate riffling or interleaving the corners of two stacks of playing cards. Such an approach is shown, for example, in U.S. Pat. Nos. 4,807,884; 5,261,667; 5,275,411; and 5,303,921. Another approach is to separate the playing cards into two distinct stacks and randomly move playing cards from each stack into a third stack. Such an approach is shown, for example, in U.S. Pat. Nos. 5,695,189; 6,068,258; 6,139,014; 6,325,373; and 6,568,678. Yet another approach is to place playing cards into random positions in a stack of playing cards carried by an elevator. Such an approach typically involves a gripper mechanism to support an upper portion of the stack, while the floor of the elevator is dropped to create a space into which the playing card is inserted. Such an approach is shown, for example, in U.S. Pat. Nos. 5,683,085; 5,944,310; 6,651,981; and 6,651,982. A further approach is to insert playing cards into selected compartments, either randomly or in a sorted order. Such an approach is shown, for example, in U.S. Pat. Nos. 6,149,154; 6,254,096; 6,267,248; 6,588,750; 6,588,751; 6,655,684; 6,659,460; 6,676,127; and 6,889,979. Still a further approach is to withdraw or eject playing cards in a random order from an array of playing card receptacles. Such an approach is shown, for example, in U.S. Pat. Nos. 5,382,024; 5,584,483; 5,676,372; 6,019,368; 6,299,167; and 6,698,756.

Whether used for randomizing or sorting, card handling devices must deliver the randomized or sorted playing cards to the user (e.g., dealer). It will typically be desirable to present the playing cards in a highly aligned stack, in a manner that the playing cards are easily and quickly accessible by the user. This may be particularly desirable where the playing cards are delivered at a gaming table in a casino environment. Casinos highly value speed, which maintains customer interest, and which allows the maximum utilization of the casino facilities. Casinos also highly value security. Thus, casinos employ elaborate mechanisms and procedures to prevent players and/or casino personnel (e.g., dealers) from gaining a knowledge of a playing card value before the playing card is dealt. Consequently, devices and methods that facilitate the easy, quick, and secure delivery of playing cards are desirable.

### SUMMARY OF THE INVENTION

In one embodiment, a system to form sets of playing cards includes an input subsystem configured to receive input indicative of at least one of a desired theoretical hold of a card game and a bonus game both played with playing cards from a set of playing cards, a rule of a game to be played with the set of playing cards or a progressive jackpot parameter; and a processing subsystem communicatively coupled to the input subsystem and configured to automatically determine a composition of the set of playing cards based at least in part on the received input, the set of playing cards including both a number of standard playing cards and a number of bonus playing cards.

In another embodiment, a method of forming a set of playing cards includes supplying a plurality of standard playing cards, each of the standard playing cards having a rank symbol indicative of a rank from a standard set of playing card ranks and a suit symbol indicative of a suit from a standard set of playing card suits; supplying at least a first bonus playing card having a first bonus symbol indicative of a first bonus value, at least one symbol on the first bonus playing card indicative of a rank from the standard set of playing card ranks; and supplying at least a second bonus playing card having a second bonus symbol indicative of a second bonus value, the second bonus symbol different from the first bonus symbol and the second bonus value different from the first bonus value, at least one symbol on the second bonus playing card indicative of a rank from the standard set of playing card ranks.

In a further embodiment, a set of playing cards includes a plurality of standard playing cards, each of the standard playing cards having a respective standard rank symbol and a standard suit symbol; a plurality of bonus playing cards, each of the bonus playing cards having a respective rank, the ranks of the plurality of bonus playing cards being equal to at least one of a set of standard ranks, where at least two of the bonus playing cards have different bonus values with respect to forming a bonus combination under the rules of a game played with the set of playing cards.

In another embodiment, a method of operating a card game played with a set of playing cards that includes a plurality of standard playing cards and a plurality of bonus playing cards, each of the standard playing cards having a respective standard rank symbol and a standard suit symbol, each of the bonus playing cards having a respective rank, the ranks of the plurality of bonus playing cards being equal to at least one of a set of standard ranks, where at least two of the bonus playing cards have different bonus values with respect to forming a bonus combination under the rules of a game played with the set of playing cards, includes for any winning hands under a set of rules of an underlying card game, paying a standard payout amount based on a standard payout schedule for the underlying card game; and for any winning hands under the set of rules of the underlying card game that contain at least one bonus playing card, paying a bonus amount based on a bonus payout schedule.

In yet a further embodiment, a system of operating a card game played with a set of playing cards that includes a plurality of standard playing cards, each of the standard playing cards having a respective standard rank symbol and standard suit symbol and a plurality of bonus playing cards, each of the bonus playing cards having a respective rank, the ranks of the plurality of bonus playing cards being equal to at least one of a set of standard ranks, where at least two of the bonus playing cards have different bonus values with respect to forming a bonus combination under the rules of a game played with the set of playing cards, includes a wager recognition subsystem that automatically identifies an amount of each of a respective wager placed by each of a number of players; a wager allocation subsystem that automatically allocates a portion of the wager placed by each of the players to a bonus jackpot pool; a bonus event subsystem that automatically determines when a bonus event occurs; and a bonus jackpot award subsystem that awards the bonus jackpot pool to a player having winning hand that includes a first number of a first type of bonus playing card when the bonus event occurs.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a playing card order and distribution environment, according to one illustrated embodiment.

FIG. 2 is a front plan view of a plurality of standard playing cards bearing standard rank and suit markings, according to one illustrated embodiment.

FIG. 3 is a front plan view of a first bonus playing card of a first bonus value and having a marking indicating a rank selected from a set of standard playing card ranks, according to one illustrated embodiment.

FIG. 4 is a front plan view of a second bonus playing card of a second bonus value and having a marking indicating a rank selected from a set of standard playing card ranks, according to one illustrated embodiment.

FIG. 5 is a front plan view of a third bonus playing card of a third bonus value and having a marking indicating a rank selected from a set of standard playing card ranks, according to one illustrated embodiment.

FIG. 6 is a block diagram of a computing system useful in implementing the playing card order and distribution environment of FIG. 1, according to one illustrated embodiment.

FIG. 7 is a schematic diagram of a user interface allowing the input of information such as desired theoretical hold, game rules, and bonus parameter; and to display output, such as the composition of a set of playing cards, to achieve the desired theoretical hold, according to one illustrated embodiment.

FIG. 8 is a flow diagram illustrating a method of operating a playing card order and distribution environment, according to one illustrated embodiment.

FIG. 9 is a flow diagram illustrating a method of determining a composition of a set of playing cards including a plurality of standard playing cards and bonus playing cards, according to one illustrated embodiment.

FIG. 10 is a flow diagram illustrating a method of determining a number of bonus playing cards of each type or bonus values to be included in the set of playing cards, according to one illustrated embodiment.

FIG. 11 is a flow diagram illustrating a method of determining a number of bonus playing cards of each type or bonus values to be included in the set of playing cards, according to another illustrated embodiment.

FIG. 12 is a flow diagram illustrating a method of determining a number of bonus playing cards of each type or bonus values to be included in the set of playing cards, according to yet another illustrated embodiment.

FIG. 13 is a flow diagram illustrating a method of determining a number of bonus playing cards of each type or bonus values to be included in the set of playing cards, according to still another illustrated embodiment.

FIG. 14 is a flow diagram illustrating a method of determining a number of bonus playing cards of each type or bonus values to be included in the set of playing cards, according to yet another illustrated embodiment.

FIG. 15 is a flow diagram illustrating a method of determining a number of bonus playing cards of each type or bonus values to be included in the set of playing cards, according to yet still another illustrated embodiment.

FIG. 16 is a flow diagram illustrating a method of forming sets of playing cards based at least in part on the determined composition, according to one illustrated embodiment.

FIG. 17 is an isometric view of a gaming environment in which the set of playing cards may be used, according to one illustrated embodiment.

FIG. 18 is front plan view of a display of a bonus payout table, according to one illustrated embodiment.

FIG. 19 is top, plan view of a dealer's hand and four (4) player's hands, illustrating a method of resolving wagers, according to one illustrated embodiment.

FIG. 20 is a flow diagram illustrating a method of resolving wagers, according to one illustrated embodiment.

FIG. 21 is a flow diagram illustrating a method of resolving a bonus portion of a card game, according to one illustrated embodiment.

FIGS. 22A and 22B are a flow diagram illustrating a method of determining a bonus payout other than a jackpot bonus payout, according to one illustrated embodiment.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with computers, computer networks, communications interfaces, sensors and/or transducers, printers, and/or presses may not be shown or described in detail to avoid unnecessarily obscuring the description.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings provided herein are for convenience only and do not interpret the scope or meaning of the claimed invention.

This description generally relates to a playing card ordering and distribution environment that allows entities, for example casinos or other gaming establishments, to order sets of playing cards to implement various table games with bonus features having desired theoretical holds. A theoretical hold represents that portion of each dollar wagered that the gaming establish will statistically retain. While the amount that an entity will actually hold may fluctuate, and may never actually match the theoretical hold, the theoretical hold provides an approximation of the amount that a gaming establishment will retain over the long term.

For purposes of clarity and brevity, the description herein may reference certain card games such as blackjack, baccarat, various types of poker, or LET IT RIDE®. However, it is understood and appreciated that this description is generally applicable to a variety of casino-type games and/or gaming tables, or may be generally applicable to other recreational card games. The playing card handling system described herein may be useful in wagering type card games and non-wagering type card games.

In addition, it is understood that the playing cards described herein do not necessarily correspond to the standard playing cards, for example cards that are larger or smaller, shaped differently, and/or made from something other than traditional card stock material. Playing cards may include one or more decks of standard playing cards, where each standard deck includes fifty-two (52) playing cards. Standard playing cards typically have uniform backs, and faces which each bear a respective combination of a first primary symbol and a second primary symbol. The first primary symbol may be selected from a standard set of playing card rank symbols (i.e., 2, 3, 4, 5, 6, 7, 8, 9, 10, J, Q, K, and A) and the second primary symbol may be selected from a standard set of playing card suit symbols (i.e., ♡, [symbol] , ♦, and [symbol] ). In some embodiments, the playing cards may include playing cards other than those found in a complete standard deck, or decks with a greater or less distribution of particular playing cards, for example less face cards or more face cards. In other embodiments, the playing cards may have non-standard symbols (e.g., slot machine symbols such as bars, lemons, cherries), graphics, backings, etc. As discussed below, the symbols may even be modified to add, enhance, or alter the value or significance of the playing card. In one embodiment, the playing cards are dual sided playing cards as described in U.S. patent application Ser. No. 10/902,436, which published on Jun. 2, 2005.

### Brief Overview of the Playing Card Order and Distribution Environment

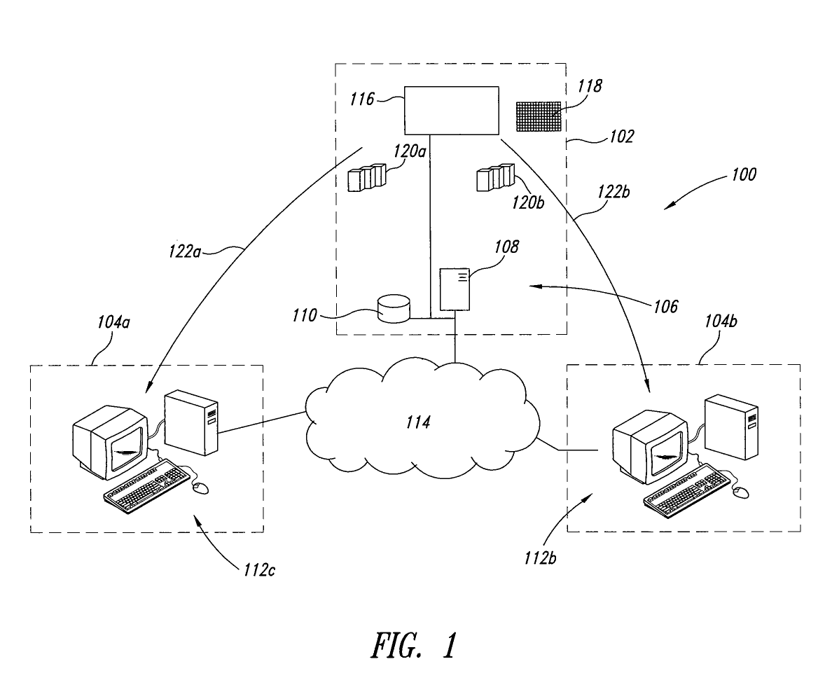

FIG. 1 shows a playing card order and distribution environment 100, according to one illustrated embodiment.

The playing card order and distribution environment 100 may include a playing card forming entity, for example a playing card manufacturer 102. The playing card order and distribution environment 100 may include and one or more playing card using entities, for example one or more casinos or gaming establishments 104a, 104b (collectively 104).

The playing card manufacturer 102 may operate or otherwise access a playing card composition computing system 106. The playing card composition computing system 106 may include one or more computers 108 and one or more databases 110. The casinos 104 may each operate or otherwise access one or more casino computing systems 112a, 112b, (collectively 112), which are communicatively coupled to the playing card composition computing system 106 by one or more networks 114. As discussed herein, the playing card composition computing system 106 allows the casinos 104 to determine the composition of sets of playing cards which will provide a desired theoretical hold for card games with bonus options, by specifying the desired theoretical holds, rule(s) of the card game, and/or bonus related parameters.

The composition of a set of playing cards may include an indication of the total number of playing cards in the set and the number and distribution of various standard playing cards in the set, as well as the number and distribution of various bonus playing cards in the set. In some embodiments, the sets may include 52 playing cards. In other embodiments, the sets may include a greater number of playing cards. For example, some embodiments may employ integer multiples of 52 playing cards. Some embodiments may employ a smaller number of playing cards, or non-integer multiples of 52 playing cards.

The playing card manufacturer 102 may operate or otherwise access a playing card forming system 116. The playing card forming system 116 may include one or more printers or presses (e.g., offset, lithographic, screen print) configured to print or otherwise form playing cards, for example as sheets of playing cards 118. The playing card manufacturer 102 may operate or otherwise employ suitable equipment such as cutting machines to cut the sheets 118 to form individual playing cards. The playing card manufacturer 102 may form or collate and/or package the individual playing cards into sets of playing cards 120a, 120b (collectively 120) having the determined composition. The playing card manufacturer 102 may deliver sets of playing cards 120, as indicated by arrows 122a, 122b (collectively 122) to the casinos 104.

While FIG. 1 and the above discussion locates the playing card composition computing system 106 with the playing card manufacturer 102, in some embodiments the playing card composition computing system 106 may be located with the casinos 104 or may be located or operated with some other entity. In some embodiments, some portion(s) of the playing card composition computing system 106 or function(s) thereof may be located with the playing card manufacturer 102, while other portion(s) of the playing card composition computing system 106 or function(s) thereof may be located with the casinos 104 or may be located or operated via some other entity.

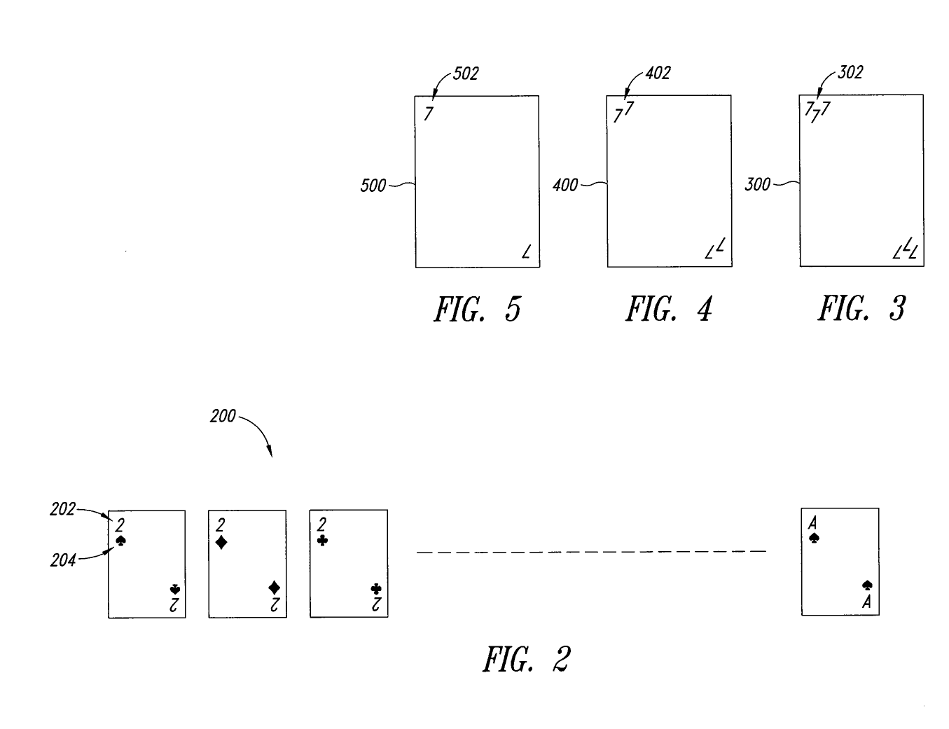

FIG. 2 shows a set of standard playing cards 200, according to one illustrated embodiment.

The playing cards 200 each bear a rank symbol 202 (only one called out in FIG. 2) and a suit symbol 204 (only one called out in FIG. 2). The rank symbol 202 may be selected from a set of standard rank symbols (i.e., 2, 3, 4, 5, 6, 7, 8, 9, 10, J, Q, K, and A). In some embodiments, the rank symbol 202 may be selected from less than the full set of standard rank symbols (i.e., 2, 3, 4, 5, 6, 8, 9, 10, J, Q, K, and A). The suit symbol 204 may be selected from a set of standard suit symbols (i.e., ♡, [symbol] , ♦, and [symbol] ). Some embodiments may omit the suit symbol entirely. For example, the suit symbol may be omitted in some embodiments where the card game does not employ the suit, for instance blackjack. In some embodiments, the sets of playing cards 120 (FIG. 1) may include multiple instances of playing cards have identical rank and suit combinations, or may omit some rank and suit combinations.

FIG. 3 shows a first bonus playing card 300, according to one illustrated embodiment.

The first bonus playing card 300 may include a symbol 302 that represents a rank. The rank may be selected from the set of standard ranks (i.e., 2, 3, 4, 5, 6, 7, 8, 9, 10, J, Q, K, and A). As illustrated, the symbol 302 is indicative of the rank of 7. The symbol 302, or another symbol, may also be indicative of a bonus value of the bonus playing card 300 in forming a bonus combination that entitles a player to a bonus payout. As illustrated, the first bonus playing card 300 is illustrative of a triple 7 bonus value. In some embodiments, the bonus playing card 300 may omit any symbol indicative of suit. Such may be particularly suitable for use in play of underlying card games that do not employ suit, for example blackjack or baccarat. In other embodiments, the bonus playing card 300 may include a symbol indicative of suit. Such may be particularly suitable for use in play of underlying card games that employ suit, for example various forms of poker.

FIG. 4 shows a second bonus playing card 400, according to one illustrated embodiment.

The second bonus playing card 400 may include a symbol 402 that represents a rank. The rank may be selected from the set of standard ranks (i.e., 2, 3, 4, 5, 6, 7, 8, 9, 10, J, Q, K, and A). The rank may advantageously be equal to the rank of the first bonus playing card 300. As illustrated, the symbol 402 is indicative of the rank of 7. The symbol 402, or another symbol, may also be indicative of a bonus value of the playing card 400 in forming a bonus combination that entitles a player to a bonus payout. As illustrated, the second bonus playing card 400 is illustrative of a double 7 bonus value.

FIG. 5 shows a third bonus playing card 500, according to one illustrated embodiment.

The third bonus playing card 500 may include a symbol 502 that represents a rank. The rank may be selected from the set of standard ranks (i.e., 2, 3, 4, 5, 6, 7, 8, 9, 10, J, Q, K, and A). The rank may advantageously be equal to the rank of the first and the second bonus playing cards 300, 400, respectively. As illustrated, the symbol 502 is indicative of the rank of 7. The symbol 502, or another symbol, may also be indicative of a bonus value of the playing card 500 in forming a bonus combination that entitles a player to a bonus payout. As illustrated, the third bonus playing card 500 is illustrative of a single 7 bonus value.

### Computing Environment

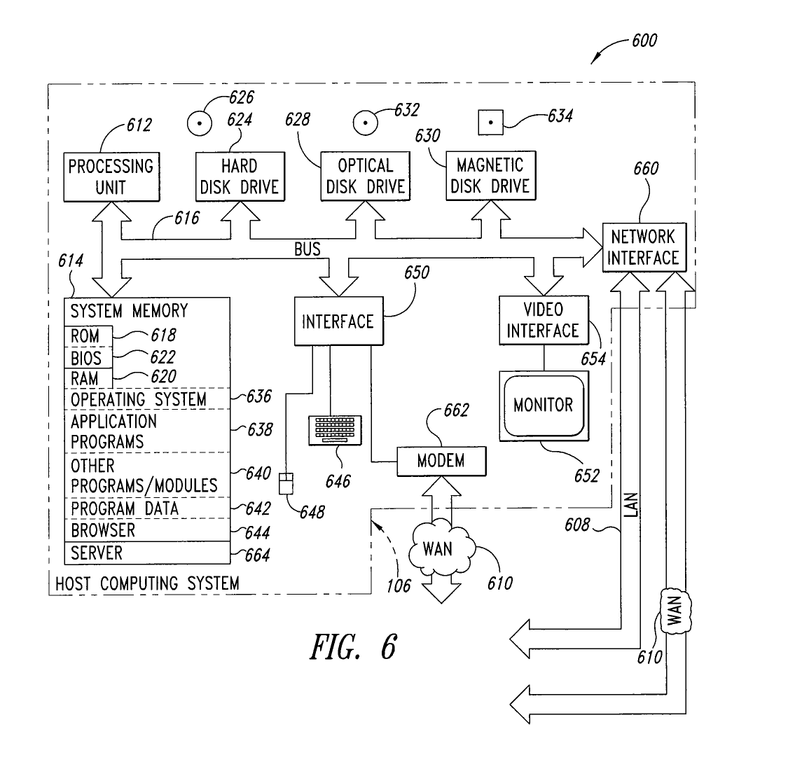

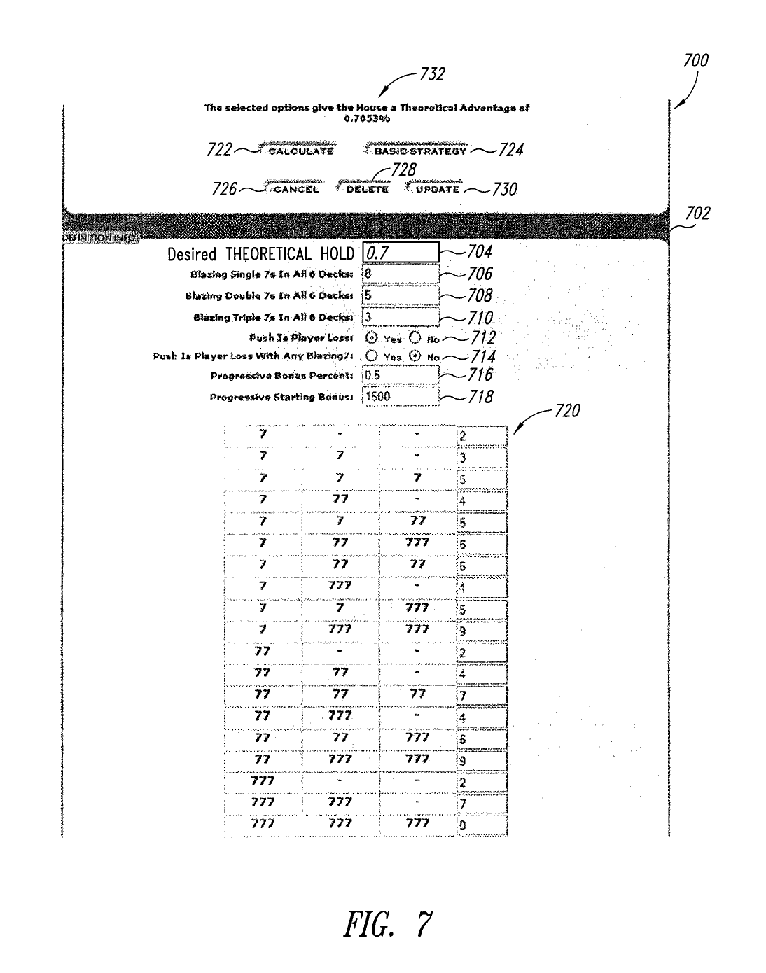

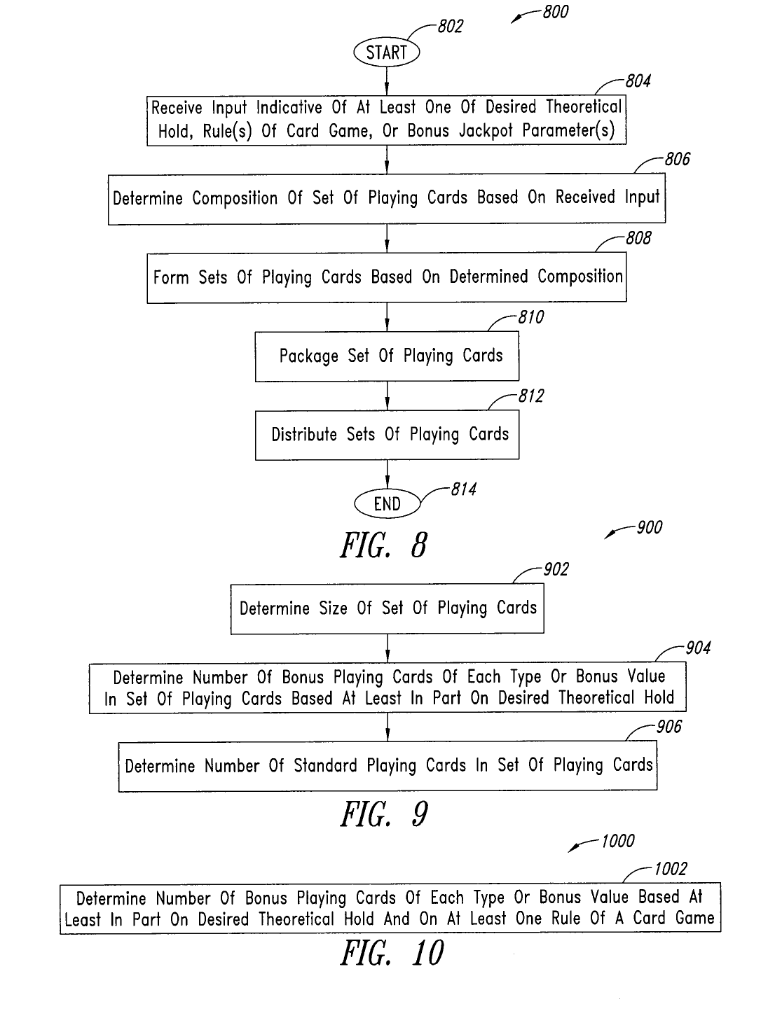

FIG. 6 and the following discussion provide a brief, general description of a suitable computing environment 600 in which the various illustrated embodiments can be implemented. Although not required, the embodiments will be described in the general context of computer-executable instructions, such as program application modules, objects, or macros being executed by a computer. Those skilled in the relevant art will appreciate that the illustrated embodiments, as well as other embodiments, can be practiced with other computer system configurations, including hand-held devices, multiprocessor systems, microprocessor-based or programmable consumer electronics, personal computers (“PCs”), network PCs, mini computers, mainframe computers, and the like. The embodiments can be practiced in distributed computing environments where tasks or modules are performed by remote processing devices, which are linked through a communications network. In a distributed computing environment, program modules may be located in both local and remote memory storage devices.

FIG. 6 shows the computing environment 600 comprising one or more playing card composition computing systems 106, which may be communicatively coupled to the casino computing systems 112 and/or playing card forming system 116 by one or more communications channels, for example one or more local area networks (LANs) 608 or wide area networks (WANs) 610. The computing environment 600 may employ other computers, such as conventional personal computers, where the size or scale of the system allows.

The playing card composition computing system 106 may take the form of a conventional mainframe or mini-computer, that includes a processing unit 612, a system memory 614, and a system bus 616 that couples various system components including the system memory 614 to the processing unit 612. The playing card composition computing system 106 will at times be referred to in the singular herein, but this is not intended to limit the embodiments to a single playing card composition computing system 106 since in typical embodiments, there will be more than one playing card composition computing system 106 or other device involved.

The processing unit 612 may be any logic processing unit, such as one or more central processing units (CPUs), digital signal processors (DSPs), application-specific integrated circuits (ASICs), etc. Unless described otherwise, the construction and operation of the various blocks shown in FIG. 6 are of conventional design. As a result, such blocks need not be described in further detail herein, as they will be understood by those skilled in the relevant art.

The system bus 616 can employ any known bus structures or architectures, including a memory bus with memory controller, a peripheral bus, and a local bus. The system memory 614 includes read-only memory (“ROM”) 618 and random access memory (“RAM”) 620. A basic input/output system (“BIOS”) 622, which can form part of the ROM 618, contains basic routines that help transfer information between elements within the playing card composition computing system 106, such as during start-up.

The playing card composition computing system 106 also includes a hard disk drive 624 for reading from and writing to a hard disk 626, and an optical disk drive 628 and a magnetic disk drive 630 for reading from and writing to removable optical disks 632 and magnetic disks 634, respectively. The optical disk 632 can be a CD-ROM, while the magnetic disk 634 can be a magnetic floppy disk or diskette. The hard disk drive 624, optical disk drive 628, and magnetic disk drive 630 communicate with the processing unit 612 via the system bus 616. The hard disk drive 624, optical disk drive 628, and magnetic disk drive 630 may include interfaces or controllers (not shown) coupled between such drives and the system bus 616, as is known by those skilled in the relevant art. The drives 624, 628 and 630, and their associated computer-readable media 626, 632, 634, provide nonvolatile storage of computer readable instructions, data structures, program modules, and other data for the playing card composition computing system 106. Although the depicted playing card composition computing system 106 employs hard disk 624, optical disk 628, and magnetic disk 630, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, etc.

Program modules can be stored in the system memory 614, such as an operating system 636, one or more application programs 638, other programs or modules 640, and program data 642. The system memory 614 may also include communications programs, for example a Web client or browser 644 for permitting the playing card composition computing system 106 to access and exchange data with sources such as Web sites of the Internet, corporate intranets, or other networks as described below, as well as other server applications on server computing systems such as those discussed further below. The browser 644 in the depicted embodiment is markup language based, such as Hypertext Markup Language (HTML), Extensible Markup Language (XML), or Wireless Markup Language (WML), and operates with markup languages that use syntactically delimited characters added to the data of a document to represent the structure of the document. A number of Web clients or browsers are commercially available such as those from America Online and Microsoft of Redmond, Wash.

While shown in FIG. 6 as being stored in the system memory 614, the operating system 636, application programs 638, other programs/modules 640, program data 642, and browser 644 can be stored on the hard disk 626 of the hard disk drive 624, the optical disk 632 of the optical disk drive 628, and/or the magnetic disk 634 of the magnetic disk drive 630. An operator, such as authorized personnel of the playing card manufacturer or distributor, can enter commands and information into the playing card composition computing system 106 through input devices such as a touch screen or keyboard 646 and/or a pointing device such as a mouse 648. Other input devices can include a microphone, joystick, game pad, tablet, scanner, etc. These and other input devices are connected to the processing unit 612 through an interface 650 such as a serial port interface that couples to the system bus 616, although other interfaces such as a parallel port, a game port, a wireless interface, or a universal serial bus (“USB”) can be used. A monitor 652 or other display device is coupled to the system bus 616 via a video interface 654, such as a video adapter. The playing card composition computing system 106 can include other output devices, such as speakers, printers, etc.

The playing card composition computing system 106 can operate in a networked environment using logical connections to one or more remote computers and/or devices, for example the casino computing systems 112 via one or more servers, hubs, routers, etc. The server can be another personal computer, a server, another type of computer, or a collection of more than one computer communicatively linked together, and typically includes many or all of the elements described above for the playing card composition computing system 106. The server may be logically connected to one or more of the playing card composition computing system 106 under any known method of permitting computers to communicate, such as through one or more LANs 608 and/or WANs 610 such as the Internet. Such networking environments are well known in wired and wireless enterprise-wide computer networks, intranets, extranets, and the Internet. Other embodiments include other types of communication networks including telecommunications networks, cellular networks, paging networks, and other mobile networks.

When used in a LAN networking environment, the playing card composition computing system 106 is connected to the LAN 608 through an adapter or network interface 660 (communicatively linked to the system bus 616). When used in a WAN networking environment, the playing card composition computing system 106 may include a modem 662 or other device, such as the network interface 660, for establishing communications over the WAN 610. The modem 662 is shown in FIG. 6 as communicatively linked between the interface 650 and the WAN 610. In a networked environment, program modules, application programs, or data or portions thereof, can be stored in the playing card composition computing system 106. As noted above, the playing card composition computing system 106 may be communicatively linked to the casino computing systems 112 and/or playing card forming system 116 through the LANs 608 and/or WAN 610, for example with TCP/IP middle layer network protocols. However, other similar network protocol layers are used in other embodiments, such as User Datagram Protocol (“UDP”). Those skilled in the relevant art will readily recognize that the network connections shown in FIG. 6 are only some examples of establishing communication links between computers, and other links may be used, including wireless links.

In some embodiments, the playing card composition computing system 106 includes server applications 664 for the routing of instructions, programs, data, and agents between the casino computing systems 112 and/or playing card forming system 116. For example the server applications 664 may include conventional server applications such as WINDOWS NT 4.0 Server, and/or WINDOWS 2000 Server, available from Microsoft Corporation of Redmond, Wash. Additionally, or alternatively, the server applications 664 can include any of a number of commercially available Web servers, such as INTERNET INFORMATION SERVICE from Microsoft Corporation and/or IPLANET from Netscape.

It is understood that any suitable processor based system may be employed in the playing card composition computing system 106. The processing system may be a specially designed and/or fabricated processing system, or a commercially available processor system. Non-limiting examples of commercially available processor systems include, but are not limited to, an 80×86 or Pentium series microprocessor from Intel Corporation, U.S.A., a PowerPC microprocessor from IBM, a Spare microprocessor from Sun Microsystems, Inc., a PA-RISC series microprocessor from Hewlett-Packard Company, or a 68xxx series microprocessor from Motorola Corporation.

FIG. 7 shows a user interface 700 to facilitate the determination of the composition of playing card sets 120 (FIG. 1), according to one illustrated embodiment.

The user interface 700 may include one or more displays and user input devices, such as those of the casino computing systems 112 (FIG. 1). The displays may take the form of touch screen displays. Alternatively, or additionally, the user interface 700 may employ a separate user input device, for example a keyboard or keypad. The user interface 700 may further include one or more sound transducers, such as a speaker and/or microphone. The user interface 700 may include one or more controllers, memories, and/or other devices, and may store and execute one or more applications for providing information to, and collecting information from, the users. Additionally, the user interface 700 may include instructions for handling security such as password or other access protection and communications encryption.

The user interface may include a GUI 702 that allows casino personnel or others to select or enter various options or parameters in order to determine a composition of a set of cards to produce a card game with a bonus option that provides a desired theoretical hold or house advantage.

For example, the GUI 702 may include a desired theoretical hold field 704, to allow the user to select or enter a desired theoretical hold. The GUI 702 may provide a number of predefined theoretical holds or house advantages, or may receive any desired theoretical hold or house advantage defined by the user.

Also for example, the GUI 702 may include a single bonus value field 706, to allow the user to select or enter a value indicative of a total number of bonus playing cards (e.g., 500, FIG. 5) of a single bonus value (e.g., 502) to be included in the set of playing cards 120 (FIG. 1). Also for example, the GUI 702 may include a double bonus value field 708, to allow the user to select or enter a value indicative of a total number of bonus playing cards (e.g., 400, FIG. 4) of a double bonus value (e.g., 402) to be included in the set of playing cards 120. Also for example, the GUI 702 may include a triple bonus value field 710, to allow the user to select or enter a value indicative of a total number of bonus playing cards (e.g., 300, FIG. 3) having a triple bonus value (e.g., 302) to be included in the set of playing cards 120. The GUI 702 may include additional fields to allow the specification of bonus playing cards of additional or other bonus values.

The GUI 702 may also permit the user to select from a variety of game rules or options for the underlying card game. For example, the GUI 702 may include a push field 712, to allow the user to indicate whether a tie or “push” is considered to be a loss to a player. Additionally, or alternatively, the GUI 702 may include a push with bonus card field 714, to allow the user indicate whether a tie or “push” with a bonus playing card (e.g., 300, 400, 500) in the hand is considered to be a loss to a player. The GUI 702 may include additional fields for specifying game parameters. For example, the GUI 702 may include one or more fields that allow the user to select between various card games, for example blackjack, baccarat, and/or various types of poker.

The GUI 702 may also permit the players 1710 to select from a variety of bonus and/or progressive gaming options or parameters. For example, the GUI 702 may include an allocation field 716, to allow the user to select or enter an amount of each wager to be allocated to a progressive jackpot. The amount may, for example, be represented as a percentage of each wager on the underlying card game that will be allocated to the bonus jackpot or pool. Also for example, the GUI 702 may include a starting bonus field 718, to allow the user to select or enter a progressive starting bonus amount. The GUI may include additional fields to allow the specification of other bonus parameters.

A frequency table 720 provides an indication of the statistical likelihood of various combinations of bonus playing cards 300, 400, 500 appearing over the course of play with the set of playing cards 120 having the specified composition. For example, a hand with a single bonus playing card 500 of the third bonus value 502 will likely occur twice (first row of table), while a hand with a pair of bonus playing cards 500 of the third bonus value 502 will occur three times (second row of table).

The GUI 702 may include a variety of user selectable icons to allow the user to operate and control the GUI 702. For example, a calculate icon 722 allows the user to calculate a theoretical hold for a given set of parameters. Selection of a basic strategy icon 724 produces a chart or list of all possible playing card combinations (e.g., hands of standard and/or bonus playing cards) and the best player action (e.g., hit or stand) given the particular combination hit. The basis strategy determination takes into account the underlying card game, the payout table of the bonus game, and any changes to the composition of the standard playing cards 200 (e.g., fewer or greater number of standard playing cards) may have on the outcome. A cancel icon 726 allows the user to cancel the current determination and underlying parameters of all fields or selections. A delete field 728 allows the user to delete one or more parameters of a currently selected field or icon. An update field 730 allows the user to save and name a current configuration (i.e., composition, game rule(s), bonus parameter(s)). A theoretical advantage field 732 displays the determined theoretical advantage enjoyed by the house for a given set of parameters. The GUI 702 may also allow the user to specify text, graphics, and/or formatting to customize the set of playing cards 120, for example for a specific gaming establishment or event (e.g., tournament, convention, show, promotion).

### Operation

FIG. 8 shows a method 800 of producing sets of playing cards 120, according to one illustrated embodiment.

The method 800 starts at 802. For example, the method 800 may start in response to casino personnel accessing the playing card composition computing system 106 (FIG. 1) via the casino computing system 112.

At 804, the playing card composition computing system 106 receives input indicative of at least one of a desired theoretical hold, rule(s) of a card game, and/or bonus jackpot parameter(s). The desired theoretical hold may, for example, represent a desired amount of each dollar wagered that the casino or other gaming establishment would statistically retain over the long term. The desired theoretical hold may, for example, be represented as a percentage. The card game rules may, for example, indicate the type of card game (e.g., blackjack, baccarat, poker, etc.) and/or specific rules of the card game. The bonus jackpot parameters may, for example, indicate an amount of each wager on the underlying card game that will be allocated to a jackpot bonus or pool, and/or may indicate a starting amount of the jackpot bonus or pool.

At 806, the playing card composition computing system 106 determines the composition of the set of playing cards 120 based on the received input. The playing card composition computing system 106 may execute a set of instructions that employ a statistical package to determine the composition of the set of playing cards 120. As previously noted, the composition may include the total number of playing cards in the set of playing cards 120, and the number and types of bonus playing cards 300, 400, 500 in the set of playing cards 120, as well as the number of standard playing cards 200 in the set of playing cards 120. The playing card composition computing system 106 may determine a composition that produces the desired theoretical hold based on the theoretical hold of the underlying card game, and the theoretical hold of the bonus game. Where the bonus playing cards substitute for standard playing cards of like rank, the theoretical hold of the underlying card game is not effected by the use of bonus playing cards. Thus, the desired theoretical hold will be a function of the percentage of the wagers that are allocated to the jackpot bonus or pool, the theoretical hold of the bonus game, and the unchanged theoretical hold of the underlying card game. Alternatively, or additionally, the playing card composition computing system 106 may determine the resulting theoretical hold based on a proposed composition of the set of playing cards, game rule(s), and/or bonus parameter(s). In such an embodiment, the casino personnel may iteratively determine the desired composition that will result in a desired theoretical hold.

The playing card composition computing system 106 may advantageously permit a theoretical hold to be set for a gaming establishment or even a specific one or more gaming tables 1702. The theoretical hold represents the advantage of the house (e.g., casino) for a particular game. The theoretical hold is typically based on the combination of the card game rules and the casino rules, if any, and assumes that the participants play with perfect strategy. Participants rarely play with perfect strategy, hence the term “theoretical hold.”

It is customary in most casinos to set a theoretical hold of at least 0.5%, which may be referred to as a “positive hold” and means that the house would earn 0.5% of every dollar wagered for the particular game. For some games, like LET IT RIDE® for example, the theoretical hold can be as high as 30%.

Accordingly, the casino could entice players to play at a table with a larger than customary theoretical hold by providing large incentives for participants that did well against the house on such a table.

By way of another non-limiting example, the casino could set the theoretical hold to favor the participants, instead of the house. This type of gaming table 102 would have a “negative theoretical hold.” One reason for having a negative theoretical hold would be to attract beginner players that may not want to wager a lot, but are also not willing to lose a lot either. Thus, the gaming table 1702 with the negative hold would provide beginning players a chance to play the game for awhile, learn the game, and hopefully walk away feeling successful and possibly ready to play at more challenging tables. Based on the foregoing, the playing card composition computing system 106 could advantageously be used to set the theoretical hold within a range of −10% to 40%, for example. The negative percentages represent theoretical holds that favor the participants, while the positive percentages represent theoretical holds that favor the house. It is appreciated that the aforementioned theoretical hold range is not meant to limit the scope of this application and it is understood that the value of the theoretical hold for a particular gaming establishment or gaming table 1702 is solely within the discretion of the house.

At 808, the playing card manufacturer 102 (FIG. 1) forms sets of playing cards based on the determined composition. For example, the playing card manufacturer 102 may operate one or more playing card forming systems 116 to print sheets of playing cards 118. The playing card manufacturer 102 may operate one or more cutting machines to cut the sheets into individual playing cards. At 810, the playing card manufacturer 102 packages sets of playing cards 120. At 812, the playing card manufacturer 102 distributes 122 (FIG. 1) the packaged sets of playing cards. For example, the playing card manufacturer 102 may transport the sets of playing cards 120 by any known method of conveyance. In some embodiments, the composition of the set of playing cards 120 may be electronically distributed to one or more disparate locations for printing. In some embodiments, such locations may include casinos and other gaming establishments.

The method 800 terminates at 814.

FIG. 9 shows a method 900 of determining a composition of a set of playing cards, according to one illustrated embodiment. The method 900 may be suitable for use in the method 800 (FIG. 8).

At 902, the playing card composition computing system 106 determines the size of a set of playing cards. At 904, the playing card composition computing system 106 determines the number of bonus playing cards 300, 400, 500 (FIGS. 3, 4, and 5) of each type or bonus value to be included in the set of playing cards 120, based at least in part on a desired theoretical hold. At 906, the playing card composition computing system 106 determines the number of standard playing cards 200 (FIG. 2) to be included in the set of playing cards 120.

FIG. 10 shows a method 1000 of determining the number of bonus playing cards, according to one illustrated embodiment. The method 1000 may be suitable for use in the method 900 (FIG. 9).

At 1002, the playing card composition computing system 106 determines the number of bonus playing cards 300, 400, 500 (FIGS. 3, 4, and 5) of each type or bonus value based at least in part on a desired theoretical hold and on at least one rule of a card game.

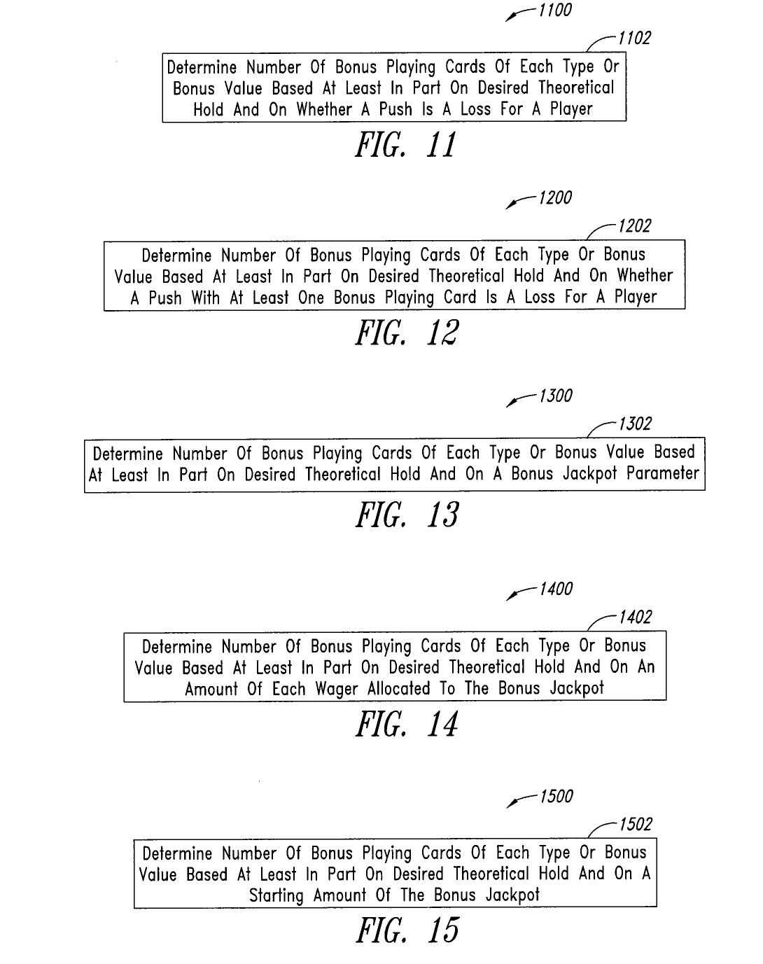

FIG. 11 shows a method 1100 of determining the number of bonus playing cards to be included in the set of playing cards 120, according to another illustrated embodiment. The method 1100 may be suitable for use in the method 1000 (FIG. 10).

At 1102, the playing card composition computing system 106 determines the number of bonus playing cards 300, 400, 500 (FIGS. 3, 4, and 5) of each type or bonus value based at least in part on a desired theoretical hold and on whether a tie or push is treated as a loss for a player.

FIG. 12 shows a method 1200 of determining a number of bonus playing cards to be included the set of playing cards 120, according to another illustrated embodiment. The method 1200 may be suitable for use in the method 1000 (FIG. 10).

At 1202, the playing card composition computing system 106 determines the number of bonus playing cards 300, 400, 500 (FIGS. 3, 4, and 5) of each type or bonus value based at least in part on a desired theoretical hold and on whether a tie or push with at least one bonus playing card 300, 400, 500 (FIGS. 3, 4, and 5) is treated as a loss for a player.

FIG. 13 shows a method 1300 of determining a number of bonus playing cards to be included in the set of playing cards 120, according to another illustrated embodiment. The method 1300 may be suitable for use in the method 900 (FIG. 9).

At 1302, the playing card composition computing system 106 determines the number of bonus playing cards 300, 400, 500 (FIGS. 3, 4, and 5) of each type or bonus value to be included in the set of playing cards 120 based at least in part on a desired theoretical hold and on a bonus jackpot parameter.

FIG. 14 shows a method 1400 of determining the number of bonus playing cards to be included in the set of playing cards 120 based at least in part on a desired theoretical hold and a bonus jackpot parameter. The method 1400 may be suitable for use in the method 1300 (FIG. 13).

At 1402, the playing card composition computing system 106 determines the number of bonus playing cards 300, 400, 500 (FIGS. 3, 4, and 5) of each type or bonus value to be included in the set of playing cards 120 based at least in part on a desired theoretical hold and on an amount of each wager on the underlying card game that will be allocated to a bonus jackpot.

FIG. 15 shows a method 1500 of determining a number of bonus playing cards to be included in the set of playing cards 120 based at least in part on a desired theoretical hold and a bonus jackpot parameter, according to another illustrated embodiment. The method 1500 may be suitable for use in the method 1300 (FIG. 13).

At 1502, the playing card composition computing system 106 determines the number of bonus playing cards 300, 400, 500 (FIGS. 3, 4, and 5) of each type or bonus value to be included in the set of playing cards 120 based at least in part on a desired theoretical hold and on a starting amount of the bonus jackpot.

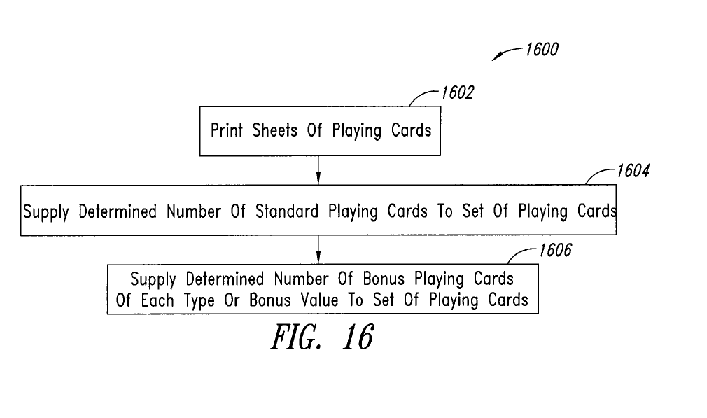

FIG. 16 shows a method 1600 of forming sets of playing cards 120 based on a determined composition. The method 1600 maybe suitable for use in the method 800 (FIG. 8).

At 1602, the playing card manufacturer 102 prints or otherwise forms sheets 118 of standard and bonus playing cards 200, 300, 400, and 500. At 1604, the playing card manufacturer 102 supplies the determined number of standard playing cards 200 to the set of playing cards 120. At 1606, the playing card manufacturer 102 supplies the determined number of bonus playing cards 300, 400, 500 of each type or bonus value 302, 402, 502 to the set of playing cards 120.

### Gaming Environment

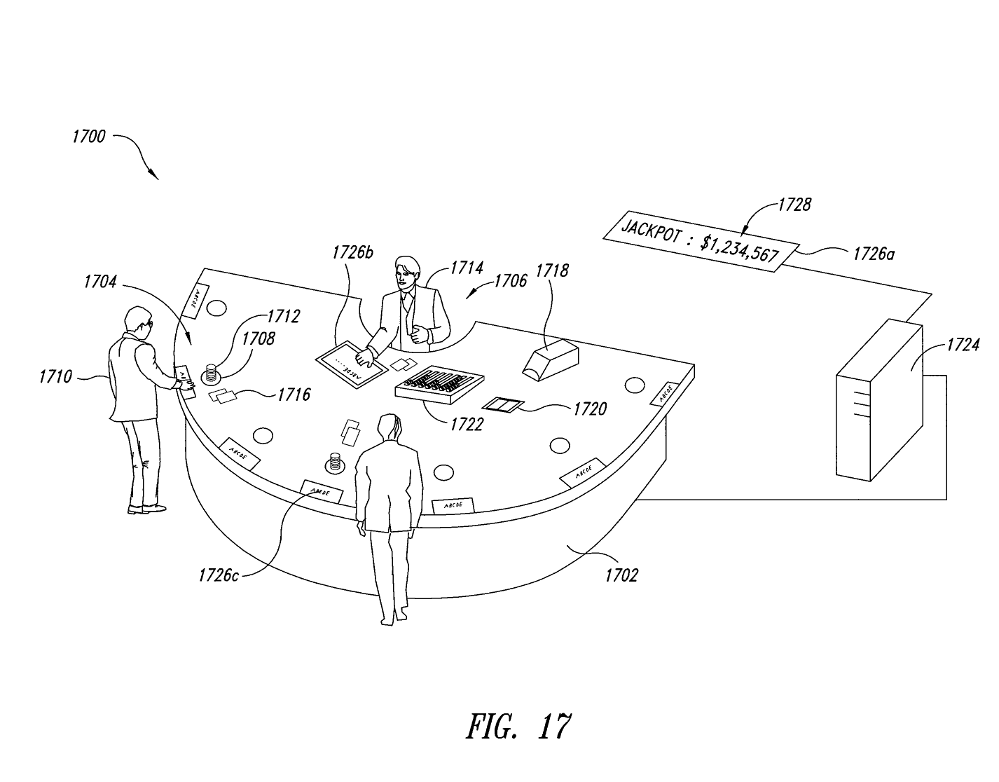

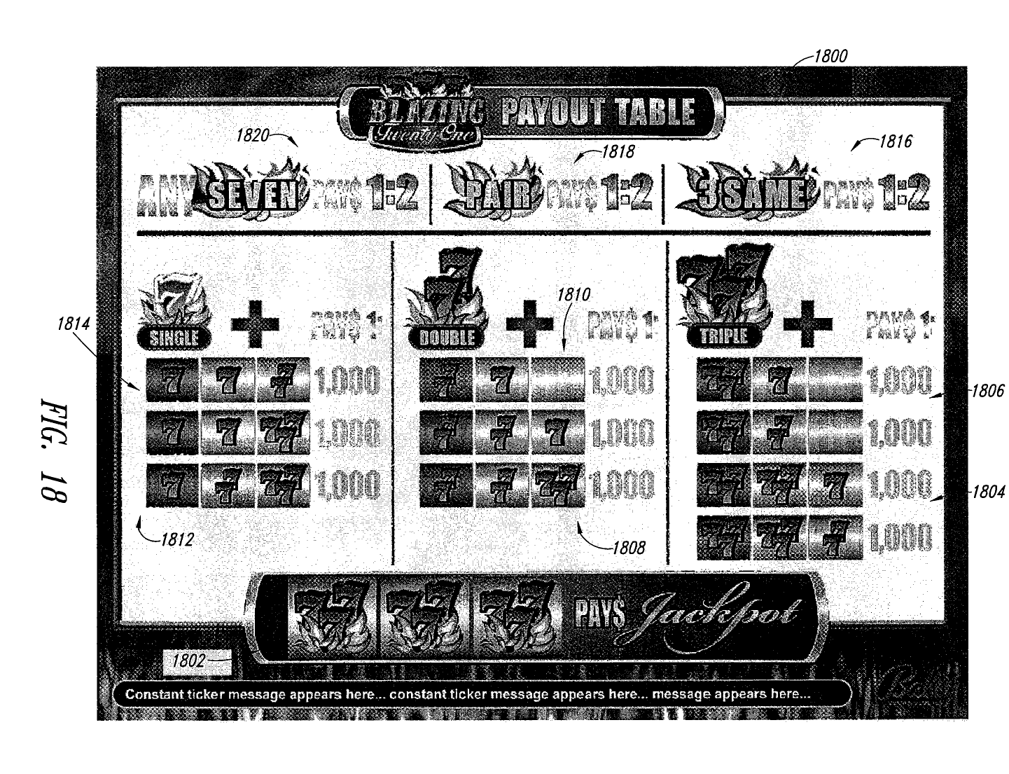

FIG. 17 shows a gaming environment 1700 according one illustrated embodiment.

The gaming environment 1700 includes one or more gaming tables 1702 having a number of player positions 1704 (only one called out in Figure) and a dealer position 1706. The player positions 1704 are typically associated with a wagering area demarcated on the playing surface of the gaming table 1702 and commonly referred to as a betting circle 1708 (only one called out in Figure). A player 1710 (only one called out in Figure) places a bet or wager by locating one or more chips 1712 or other items of value in the betting circle 1708.

A dealer 1714 deals playing cards 1716 to the players 1710. In some games, the dealer 1714 may deal playing cards to the dealer's own self. The dealer 1714 may deal playing cards 1716 from a handheld deck or from a card shoe 1718. The dealer 1714 may retrieve the playing cards 1716 from a playing card handling system 1720, for example, an automatic shuffling machine. The dealer 1714 may load the retrieved playing cards 1716 into the card shoe 1718, if the card shoe 1718 is present on the gaming table 1702. The dealer 1714 uses a chip tray 1722 for storing wagers collected from losing players 1710 and for paying out winnings to winning players 1710.

The gaming environment 1700 may also include a gaming environment computing system 1724 and one or more displays 1726a, 1726b, 1726c (collectively 1726). The gaming environment computing system 1724 is communicatively coupled to one or more systems and subsystems at the gaming table 1702, and to the displays 1726a, 1726b, 1726c. The gaming environment computing system 1724 may, for example, control or provide information to the displays 1726a, 1726b, 1726c for displaying information about the game being played at the gaming table 1702. For example, the gaming environment computing system 1724 can cause the displays 1726a, 1726b, 1726c to display a table identifier that identifies the gaming table 1702. The gaming environment computing system 1724 may also display information about the various player positions 1704. For example, the gaming environment computing system 1724 can cause the displays 1726a, 1726b, 1726c to display a status indication of the player position 1704. For example, the displays 1726a, 1726b, 1726c may display information indicating that a player position 1704 is open or is not currently open. The gaming environment computing system 1724 can cause the displays 1726a, 1726b, 1726c to display information regarding a bonus jackpot. For example, the gaming environment computing system 1724 can cause the displays 1726a, 1726b, 1726c to display a current amount of the bonus jackpot 1728, amount of time since the bonus jackpot has been won, amount of time until the next bonus jackpot will be awarded, and/or the composition of the hand or hands that have come the closest to winning the bonus jackpot.

One or more of the displays 1726a may be in the line of sight or otherwise visible from one or more of the player positions 1704, dealer positions 1706, and/or viewable by other patrons either proximate or remote from the gaming table 1702, for example visible to patrons in other areas of the gaming premises. One or more of the displays 1726b may be in the line of sight or otherwise visible from the dealer position 1706. Some embodiments may only include a display 1726b visible from the dealer position 1706, and may include a shield, polarizing filter or other features that prevent the players 1710 from seeing the information displayed on the display 1726b visible from the dealer position 1706. One or more displays 1726c (only one called out in the Figure) may be positioned proximate respective ones of the player positions 1704.

One or more displays 1726 may provide an input interface for the dealer 1714. For example, the display 1726b may take the form of a touch sensitive display, presenting a graphical user interface (GUI) with one or more user selectable icons. The display 1726b may be positioned within reach (e.g., within approximately 3 feet) of the dealer position 1706. Such may allow the dealer 1714 to enter information regarding the game in general or to enter information regarding each of the respective player positions 1704. For example, the dealer 1714 may enter buy-in amounts.

One or more displays 1726 may provide an input interface for the players 1710. For example, the displays 1726c may take the form of touch screen displays presenting a GUI with user selectable icons. The user selectable icons may allow the players 1710 to enter a player identifier to qualify for complimentary benefits (“comps”), to request services such as food or beverages, or to electronically access additional funds via credit or debit card information. Alternatively, or additionally, other user input devices may be employed, for example, keypads and/or keyboards. Some of the player 1710 related information may be displayed on the display 1726b viewable by the dealer 1714. In other embodiments, some of the player 1710 related information may be kept secret from the dealer 1714 as well as from the other players 1710.

The gaming environment 1700 may additionally include one or more sensor systems to sense wagers and/or other events occurring at the gaming table 1702. For example, one or more sensors may detect wagers. For instance, one or more imagers or cameras may be positioned in or under the chip tray 1722 to capture images of the betting circles 1708, as discussed in U.S. Pat. Nos. 6,712,696; 6,520,857; 6,517,436; 6,530,836; and 6,579,180. Also for instance, one or more antenna may be positioned in or under the chip tray 1722 to capture RF information from chips 1712 in the betting circles 1708. Also for example, one or more sensors may be located in or proximate the card shoe 1718 to detect the order in which playing cards 1716 are dealt to the participants (e.g., players 1710 and/or dealer 1714). Additionally, or alternatively, one or more sensors may be located in or proximate a discard receiving portion of the card handling system 1720 to detect playing cards collected from the participants (e.g., players 1710 and/or dealer 1714). For instance one or more imagers or cameras may be positioned in or proximate the card shoe 1718 or discard portion of the card handling system 1720, as discussed in U.S. Pat. Nos. 6,460,848; 6,595,857; 6,685,568; 6,857,961; and 6,964,612. Additionally, or alternatively, one or more sensors may be located in or proximate the chip tray 1722 to determine the contents of the chip tray 1722. For instance, one or more imagers may be located in or proximate the chip tray 1722 to capture images of the contents of the chip tray 1722 as discussed in U.S. Pat. Nos. 6,712,696; 6,579,181; and 6,517,435. Also for instance, one or more antennas may be located in or proximate the chip tray 1722 to interrogate the contents of the chip tray 1722.

Thus, various sensors may be employed to detect information from each chip 1712 and/or each playing card 1716 to identify the chip 1712 and/or playing card 1716. The sensors may collect information via images (visible, infrared, ultraviolet), radio or microwave electromagnetic radiation, and/or by detecting magnetic, inductance, or mechanical energy. Such may be implemented in the card shoe 1718, chip tray 1722, or other areas at or proximate the gaming table 1702. For example, one embodiment employs machine-readable symbol reader systems such as a bar code reader system to read machine-readable symbols such as bar code information printed on each chip 1712 and/or each playing card 1716 (typically using a non-visible medium such as ultraviolet sensitive ink or the like). Alternatively, or additionally, machine-readable symbol reader systems may read standard markings from the playing cards 1716, such as rank symbols, suit symbols, and/or pips. Another embodiment employs radio frequency identification (RFID) interrogators to read identifying information from RFID transponders in each chip 1712 and/or playing card 1716. A further embodiment employs magnetic stripe readers. Other types of sensors are possible, such as those used in electronic article surveillance (EAS).

A plurality (e.g., four) of gaming tables 1702 may be organized as a pit, and may or may not share a common display 126a and/or gaming environment computing system 1724. Thus, the display 1726a may be viewable by some or all of the players 1710 at the various gaming tables 1702. The display 1726a may be viewable by other patrons of the casino. Such may advantageously create excitement amongst the patrons. Such also advantageously allows pit bosses or other casino personnel to easily keep track of the payout or house odds selected by the players 1710 in the various player positions 1704 at multiple gaming tables 1702.

FIG. 18 shows a bonus payout table 1800, according to one illustrated embodiment.

The bonus payout table 1800 is based on the inclusion of three types of bonus playing cards (e.g., 300, 400, 500 of FIGS. 3, 4, and 5), each type associated with a respective bonus value. A first bonus value corresponds to a triple bonus value (e.g., 777), a second bonus value corresponds to a double bonus value (e.g., 77), and a third bonus value corresponds to a single bonus value (e.g., 7). The bonus playing cards 300, 400, 500 all have the same rank, which is selected from the standard playing card ranks. In the illustrated embodiment, the rank is equal to 7. In some embodiments, the set of playing cards 120 may omit the standard playing cards 200 that have the same rank as the bonus playing cards 300, 400, 500. This prevents the inclusion of the bonus playing cards 300, 400, 500 from effecting the odds of the underlying card game. It is noted that a smaller or greater number of bonus playing cards may be employed. It is also noted that bonus playing cards with ranks other than 7 may be employed and/or bonus playing cards with more than one rank may be employed. It is further noted that bonus playing cards with a smaller or greater number of bonus values may be employed.

As the payout table 1800 indicates at 1802, any player hand including three bonus playing cards of the first bonus value is paid the bonus jackpot. As the payout table 1800 indicates at 1804, any player hand including two bonus playing cards of the first bonus value along with one bonus playing card of either the second or the third bonus values is paid at 1:1000 (e.g., pays $1000 for every $1 wagered). As the payout table 1800 indicates at 1806, any player hand including one bonus playing card of the first bonus value along with one bonus playing card of either the second or the third bonus values is paid at 1:1000.

As the payout table 1800 indicates at 1808, any player hand including two bonus playing cards of the second bonus value along with one bonus playing card of either the first or the third bonus values is paid at 1:1000. As the payout table 1800 indicates at 1810, any player hand including one bonus playing card of the second bonus value along with one bonus playing card of the third bonus values is paid at 1:1000.

As the payout table 1800 indicates at 1812, any player hand including one bonus playing card of each of the first, the second and the third bonus values is paid at 1:1000. As the payout table 1800 indicates at 1814, any player hand including two bonus playing cards of the third bonus value along with one bonus playing card of either the first or the second bonus values is paid at 1:1000.

As the payout table 1800 indicates at 1816, any player hand including three bonus playing cards of a kind (e.g., three with same bonus value) is paid at 1:2 (e.g., pays $2 for every $1 wagered). As the payout table 1800 indicates at 1818, any player hand including a pair of bonus playing cards (e.g., two with same bonus value) is paid at 1:2. As the payout table 1800 indicates at 1820, any player hand including a single bonus playing card of a kind is paid at 1:2.

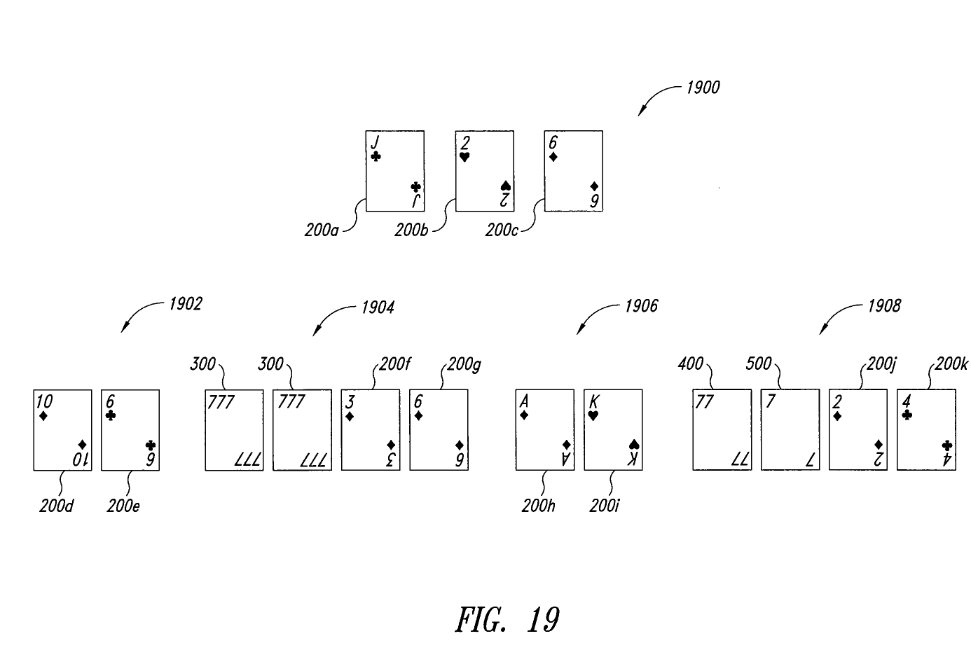

FIG. 19 shows an exemplary dealer's hand 1900 and four (4) player's hands 1902, 1904, 1906, 1908, according to one illustrated embodiment. The hands may of course contain a greater or smaller number of playing cards, and may include different playing cards than illustrated. FIG. 19 is illustrative of how an exemplary blackjack card game may be resolved, with a particular bonus structure. The teachings herein are applicable to other card games (e.g., baccarat, poker, PIA GOW POKER, CARIBBEAN STUD POKER, etc.). While denominated below as first, second, third and fourth player's hands 1902, 1904, 1906, 1908, respectively, the hands may be held by less than four players, and could be held by a single player, or perhaps by two players who have each split their hands.

The dealer's hand 1900 includes three standard playing cards 200a-200c, with ranks J, 2 and 6, having a cumulative total of 18.

A first player's hand 1902 includes two standard playing cards 200d, 200e with ranks 10 and 6, having a cumulative total of 16. As such, the first player's hand loses to the dealer's hand 1900, since the cumulative total of the dealer's hand 1900 is closer to twenty-one without exceeding twenty-one. Since the first player's hand 1902 is a loss to the player, the first player's hand does not qualify for the bonus.

A second player's hand 1904 includes two bonus playing cards 300 of the first bonus value with ranks equal to 7, and two standard playing cards 200f, 200g with ranks 3 and 6, respectively. The second player's hand has a cumulative total of 23. The second player's hand is a loss for the player since the total exceeds twenty-one, thus constitutes a “bust”. Since the second player's hand 1904 is a loss to the player, the second player's hand 1904 does not qualify for the bonus. Had the second player's hand 1904 won based on the rules of the underlying card game (e.g., blackjack), the second player's hand 1904 would have received a bonus amount of 1:2 under the bonus payout table 1800.

A third player's hand 1906 includes two standard playing cards 200h, 200i having ranks A and K, respectively, having a cumulative total of twenty-one, and is a blackjack. The third player's hand 1906 beats the dealer's hand 1900, and is a win for the player. The third player's hand 1906 qualifies for the bonus, however does not contain any bonus playing cards. Thus, the third player's hand 1906 does not receive any bonus amount under the bonus payout table 1800.

A fourth player's hand 1908 includes two bonus playing cards with ranks equal to 7, and two standard playing cards with ranks 2 and 5. The fourth player's hand 1908 has a cumulative total of 20. The fourth player's hand 1908 beats the dealer's hand 1900, and is a win for the player. The fourth player's hand 1908 qualifies for the bonus, and contains bonus playing cards of a single bonus value and a double bonus value. Thus, the fourth player's hand 1908 receives a bonus amount of 1:1000 (e.g., pays $1000 for every $1 wagered) under the bonus payout table 1800.

### Resolving Wagers in Gaming Environment

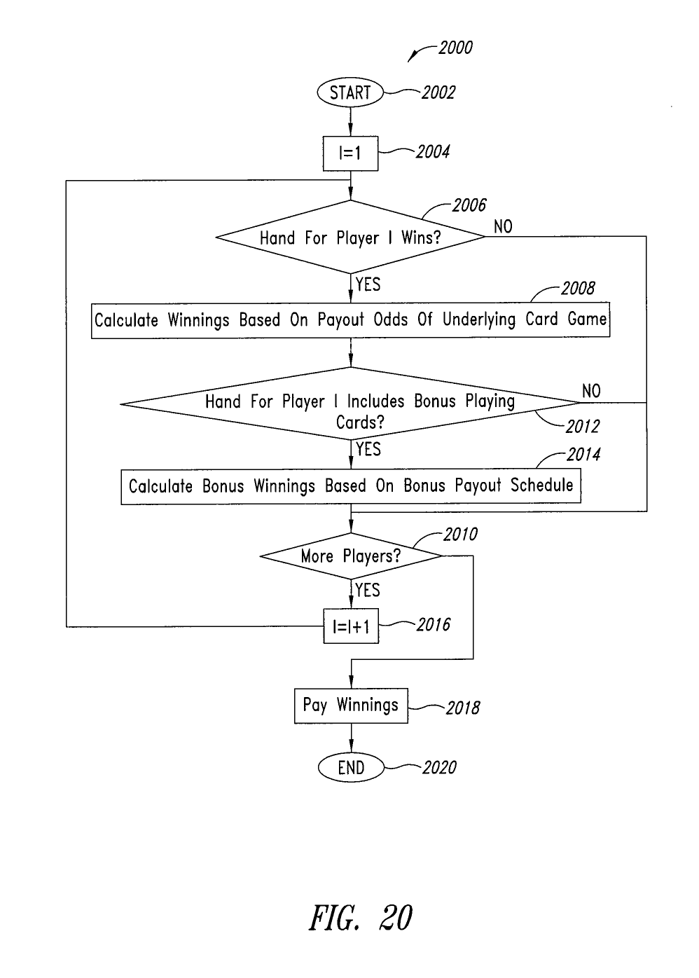

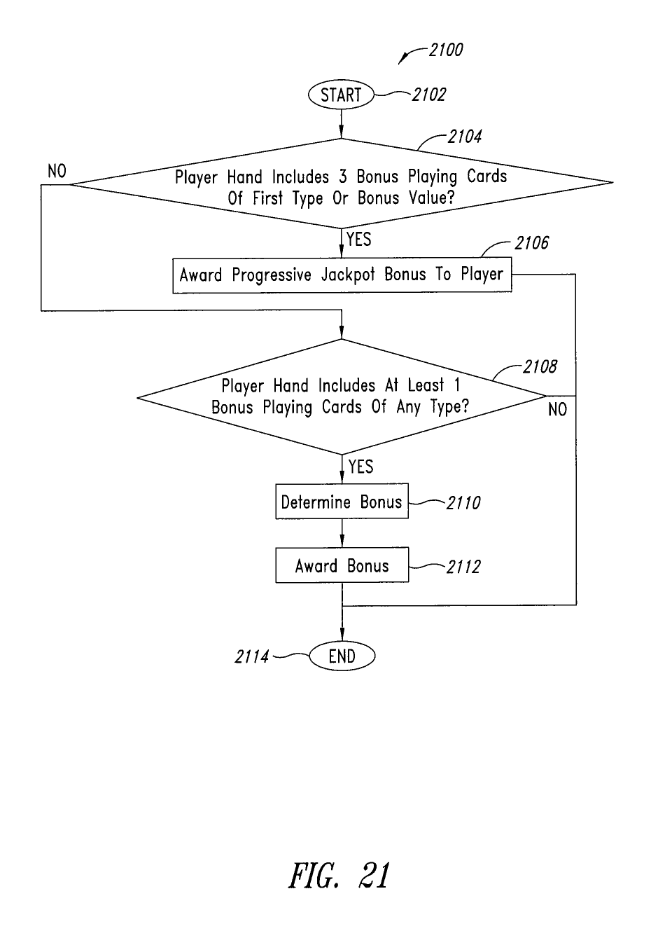

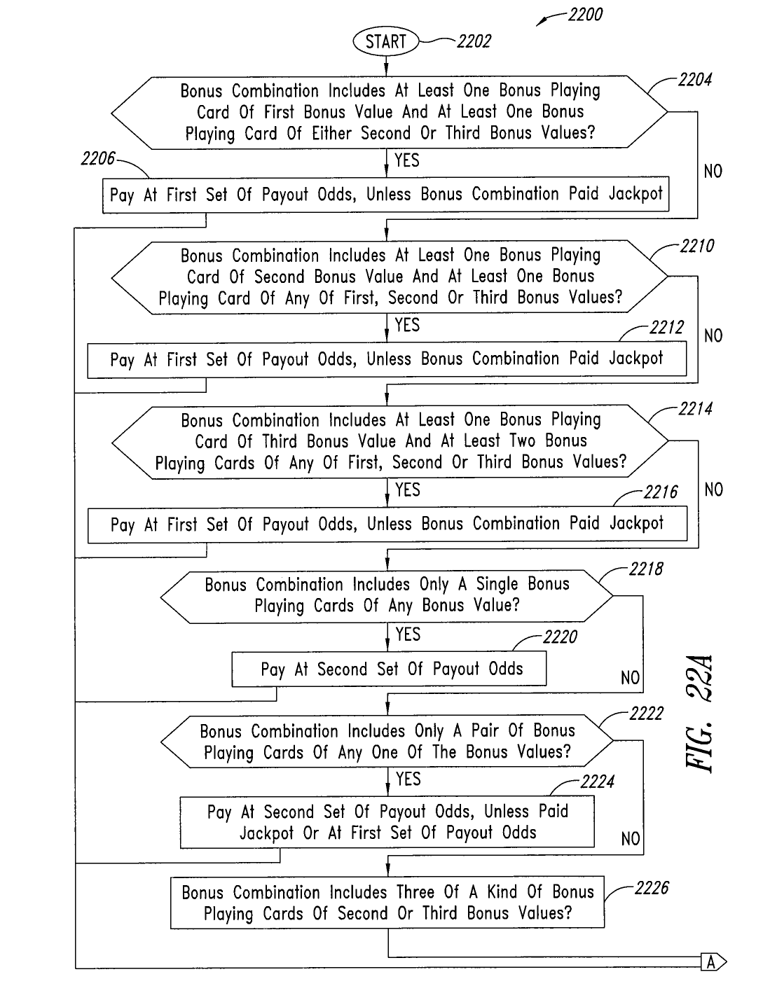

FIG. 20 shows a method 2000 of resolving wagers employing the payout table 1800 (FIG. 18), according to one illustrated embodiment. The method 2000 may be automatically implemented by the gaming environment computing system 1724, or by other systems. In some embodiments, portions or all of the method 2000 may be manually implemented.

The method 2000 starts at 2002. For example, the method 2000 may start in response to the end of one hand or round of a card game.

At 2004, a player variable I is set, for example equal to 1. At 2006, the gaming environment computing system 1724 determines whether the hand for the player I has won under the rules of the underlying card game (e.g., blackjack, baccarat, poker, PIA GOW POKER, CARIBBEAN, STUD POKER). If the hand has won, control passes to 2008, and if the hand has lost, control passes to 2010.

At 2008, the gaming environment computing system 1724 calculates the winnings for the hand based on the payout table or rules of the underlying card game. For example, in blackjack a player with a blackjack is paid at 3:2, while other winning hands are paid 1:2, and ties or pushes are not paid.

At 2012, the gaming environment computing system 1724 determines whether a winning hand includes bonus playing cards. If the winning hand includes bonus playing cards, control passes to 2014. If the winning hand does not include bonus playing cards, control passes to 2010.

At 2014, the gaming environment computing system 1724 calculates the bonus winnings based on the bonus payout schedule 1800.

At 2010, the gaming environment computing system 1724 determines whether there are more players or hands. If there are more players or hands, the gaming environment computing system 1724 increments the player count I at 2016, and returns control to 2006 to analyze the next hand.

If there are no more players or hands, the gaming environment computing system 1724 may optionally cause payment of the determined winnings at 2018. In some embodiments, the gaming environment computing system 1724 may provide a suitable indication to a dealer or other casino personnel to pay the winnings. In other embodiments, the gaming environment computing system 1724 may automatically credit a player's account with the winnings. The method 2000 then terminates at 2020.

FIG. 21 shows a method 2100 of resolving bonuses according to one illustrated embodiment. The method 2100 may be suitable for use in the method 2000 (FIG. 20).

The method 2100 starts at 2102. For example, the method 2100 may be executed by the gaming environment computing system 1724 to calculate the bonus winnings 2014 (FIG. 20).

At 2104, the gaming environment computing system 1724 determines if the player's hand includes three bonus playing cards 300 (FIG. 3) of the first type or bonus value. If the player's hand includes three bonus playing cards 300 of the first type or bonus value, a progressive jackpot bonus is awarded at 2106. If the player's hand does not include three bonus playing cards 300 of the first type or bonus value, control passes to 2108.

At 2108, the gaming environment computing system 1724 determines if the player's hand includes at least one bonus playing card of any type 300, 400, 500 (FIGS. 3, 4, and 5). If the player's hand includes at least one bonus playing card 300, 400, 500 of any type, the gaming environment computing system 1724 determines the amount of the non-jackpot bonus at 2110. At 2112, the gaming environment computing system 1724 awards the non-jackpot bonus. The method 2100 terminates at 2114.

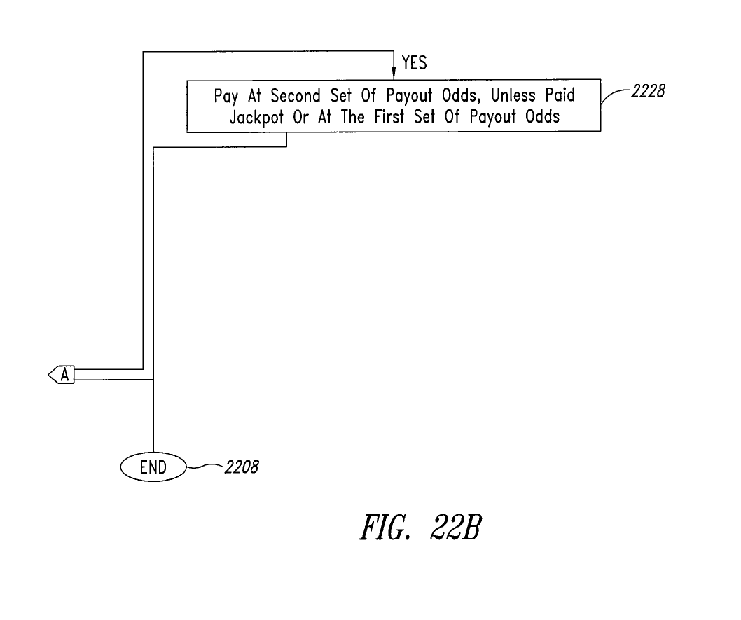

FIGS. 22A and 22B show a method 2200 of determining the bonus, according to one illustrated embodiment. The method 2200 may be suitable for use in the method 2100 (FIG. 21).

The method 2200 starts at 2202. For example, the method 2200 may start in response to a call at 2114 of the method 2100.

At 2204, the gaming environment computing system 1724 determines whether a bonus combination includes at least one bonus playing card 300 (FIG. 3) of the first bonus value and at least one bonus playing card of either the second or third bonus values 400, 500 (FIGS. 4 and 5). If the bonus combination includes at least one bonus playing card 300 of the first bonus value and at least one bonus playing card of either the second or third bonus values 400, 500, control passes to 2206. If not, control passes to 2210.

At 2206, the gaming environment computing system 1724 determines that the payout is at a first set of payout odds, unless the bonus combination was entitled to the jackpot bonus. Control then passes to 2208 where the method 2200 terminates.

At 2210, the gaming environment computing system 1724 determines whether the bonus combination includes at least one bonus playing card 400 (FIG. 4) of the second bonus value and at least one bonus playing card 300, 400, 500 of any of the first, second, or third bonus values (FIGS. 3, 4, and 5). If the bonus combination includes at least one bonus playing card 400 of the second bonus value and at least one bonus playing card 300, 400, 500 of any of the first, second, or third bonus values, control passes to 2212. If not, control passes to 2214.

At 2212, the gaming environment computing system 1724 determines that the payout is at the first set of payout odds, unless the bonus combination was entitled to the jackpot bonus. Control then passes to 2208 where the method 2200 terminates.

At 2214, the gaming environment computing system 1724 determines whether the bonus combination includes at least one bonus playing card 500 (FIG. 5) of the third bonus value and at least two bonus playing cards 300, 400, 500 of any of the first, second, or third bonus values (FIGS. 3, 4, and 5). If the bonus combination includes at least one bonus playing card 500 of the third bonus value and at least two bonus playing cards 300, 400, 500 of any of the first, second, or third bonus values, control passes to 2216. If not, control passes to 2218.

At 2216, the gaming environment computing system 1724 determines that the payout is at the first set of payout odds, unless the bonus combination was entitled to the jackpot bonus. Control then passes to 2208 where the method 2200 terminates.

At 2218, the gaming environment computing system 1724 determines whether the bonus combination includes only a single bonus playing card 300, 400, 500 (FIGS. 3, 4, and 5) of any bonus value. If the bonus combination includes only a single bonus playing card 300, 400, 500, control passes to 2220. If not, control passes to 2222.

At 2220, the gaming environment computing system 1724 determines that the payout is at a second set of payout odds, different from the first set of payout odds, unless the bonus combination was entitled to the jackpot bonus. Control then passes to 2208 where the method 2200 terminates.

At 2222, the gaming environment computing system 1724 determines whether the bonus combination includes only a pair of bonus playing cards 300, 400, 500 (FIGS. 3, 4, and 5) of any one of the bonus values. If the bonus combination includes only a pair of bonus playing cards 300, 400, 500, control passes to 2224. If not, control passes to 2226.

At 2224, the gaming environment computing system 1724 determines that the payout is at a second set of payout odds, unless the bonus combination was entitled to the jackpot bonus. Control then passes to 2208 where the method 2200 terminates.

At 2226, the gaming environment computing system 1724 determines whether the bonus combination includes three of a kind of bonus playing cards 400, 500 (FIGS. 4 and 5) of a second or third bonus value. If the bonus combination includes three of a kind of bonus playing cards 400, 500, control passes to 2228. If not, control passes to 2208 where the method 2200 terminates.

At 2228, the gaming environment computing system 1724 determines that the payout is at a second set of payout odds, unless the bonus combination was entitled to the jackpot bonus.

The above description of illustrated embodiments, including what is described in the Abstract, is not intended to be exhaustive or to limit the embodiments to the precise forms disclosed. Although specific embodiments and examples are described herein for illustrative purposes, various equivalent modifications can be made without departing from the spirit and scope of the disclosure, as will be recognized by those skilled in the relevant art. The teachings provided herein of the various embodiments can be applied to other playing card environments, not necessarily the exemplary networked playing card order and distribution environment 100 generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of computer-readable media used to actually carry out the distribution. Examples of computer-readable media include, but are not limited to, the following: recordable type media such as floppy disks, hard disk drives, CD ROMs, digital tape, and computer memory; and transmission type media such as digital and analog communication links using TDM or IP based communication links (e.g., packet links). The computer-readable medium can additionally or alternatively take the form of an electronic, magnetic, optical, electromagnetic, infrared, or semiconductor system, apparatus, device, or propagation medium. More specific examples (a nonexhaustive list) of the computer-readable medium include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium could even be paper or another suitable medium upon which the program associated with logic and/or information is printed, as the program can be electronically captured, via for instance optical scanning of the paper or other medium, then compiled, interpreted or otherwise processed in a suitable manner, if necessary, and then stored in memory.

In particular, FIGS. 8-16 and 20-22 are flow diagrams that show the architecture, functionality, and operation of a possible implementation of software for implementing a logic. In this regard, each block may represent a module, segment, or portion of code, which comprises one or more executable instructions for implementing the specified logical function(s). It should also be noted that in some alternative implementations, the functions noted in the blocks may occur out of the order noted in FIGS. 8-16 and 20-22, may omit some functions, and/or may include additional functions. For example, some blocks shown in succession may in fact be executed substantially concurrently, the blocks may sometimes be executed in the reverse order, or some of the blocks may not be executed in all instances, depending upon the functionality involved. Furthermore, some blocks of one of the flow diagrams of FIGS. 8-16 and 20-22 may be interchanged with the blocks of one of the other flow diagrams, and/or may be added to one of the other flow diagrams. All such modifications and variations are intended to be included herein within the scope of this disclosure.

As used herein and in the claims, the term “random” includes pseudo-random and the like, which are sufficiently random to meet an applicable criteria, for example criteria set by a governmental or quasi-governmental gambling authority.

The various embodiments described above can be combined to provide further embodiments. All of the above U.S. patents, patent applications, provisional patent applications and publications referred to in this specification, to include, but not be limited to, commonly assigned U.S. Provisional Application No. 60/838,280, filed Aug. 17, 2006; U.S. patent application Ser. Nos. 11/437,590, filed May 19, 2006; and Ser. No. 11/428,264, filed Jun. 30, 2006 are incorporated herein by reference in their entirety. Aspects of the invention can be modified, if necessary, to employ various systems, devices, and concepts of the various patents, applications, and publications to provide yet further embodiments of the invention.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system to form sets of playing cards, the system comprising:
an input subsystem configured to receive input indicative of at least one of a desired theoretical hold of a card game and a bonus game both played with playing cards from a set of playing cards, a rule of a game to be played with the set of playing cards or a progressive jackpot parameter; and
a processing subsystem communicatively coupled to the input subsystem and configured to automatically determine a composition of the set of playing cards based at least in part on the received input, the set of playing cards including both a number of standard playing cards and a number of bonus playing cards.

2. The system of claim 1 wherein the processing subsystem is configured to automatically determine a composition of the set of playing cards by determining a total number of bonus playing cards to include in the set of playing cards based at least in part on the desired theoretical hold.

3. The system of claim 1 wherein the processing subsystem is configured to automatically determine a composition of the set of playing cards by determining a total number of each of at least two types of bonus playing cards to include in the set of playing cards to achieve the desired theoretical hold.

4. The system of claim 1 wherein the processing subsystem is configured to automatically determine a composition of the set of playing cards by determining a total number of each of at least three types of bonus playing cards to include in the set of playing cards to achieve the desired theoretical hold.

5. The system of claim 1 wherein each of the bonus playing cards has a rank selected from a standard set of ranks, and the processing subsystem is configured to automatically determine a composition of the set of playing cards by determining a total number of each of the at least three types of bonus playing cards to include in the set of playing cards to achieve the desired theoretical hold based at least in part on a theoretical hold of an underlying card game which is resolved at least in part on the ranks of both the standard playing cards and the bonus playing cards, and a theoretical hold of a bonus game that is resolved at least in part on a respective bonus value ascribed to each of the bonus playing cards.

6. The system of claim 1 wherein each of the bonus playing cards has a rank selected from a standard set of ranks and has a bonus value independent of the rank, and the processing subsystem is configured to automatically determine a composition of the set of playing cards by determining a total number of each of the at least three types of bonus playing cards to include in the set of playing cards to achieve the desired theoretical hold based at least in part on a theoretical hold of an underlying card game which is resolved at least in part on the ranks of both the standard playing cards and the bonus playing cards, and a theoretical hold of a bonus game that is resolved at least in part on a respective one of the bonus values ascribed to each of the bonus playing cards.

7. The system of claim 6 wherein the processing subsystem is configured to automatically determine a composition of the set of playing cards by determining a total number of each of the at least three types of bonus playing cards to include in the set of playing cards to achieve the desired theoretical hold based at least in part on whether a push is treated as a loss for a player.

8. The system of claim 6 wherein the processing subsystem is configured to automatically determine a composition of the set of playing cards by determining a total number of each of the at least three types of bonus playing cards to include in the set of playing cards to achieve the desired theoretical hold based at least in part on whether a push with at least one bonus playing card in a player hand is treated as a loss for a player.

9. The system of claim 6 wherein the processing subsystem is configured to automatically determine a composition of the set of playing cards by determining a total number of each of the at least three types of bonus playing cards to include in the set of playing cards to achieve the desired theoretical hold based at least in part on a percentage of each wager allocated to a progressive bonus jackpot.

10. The system of claim 6 wherein the processing subsystem is configured to automatically determine a composition of the set of playing cards by determining a total number of each of the at least three types of bonus playing cards to include in the set of playing cards to achieve the desired theoretical hold based at least in part on a starting amount of a progressive bonus jackpot.

11. The system of claim 1 wherein the processing subsystem is configured to automatically determine a composition of the set of playing cards to include in the set of playing cards to determine a total number of each of the at least three types of bonus playing cards to achieve the desired theoretical hold based at least in part on a total size of the set of playing cards.

12. A method of forming a set of playing cards, the method comprising:
supplying a plurality of standard playing cards, each of the standard playing cards having a rank symbol indicative of a rank from a standard set of playing card ranks and a suit symbol indicative of a suit from a standard set of playing card suits;
supplying at least a first bonus playing card having a first bonus symbol indicative of a first bonus value, at least one symbol on the first bonus playing card indicative of a rank from the standard set of playing card ranks; and
supplying at least a second bonus playing card having a second bonus symbol indicative of a second bonus value, the second bonus symbol different from the first bonus symbol and the second bonus value different from the first bonus value, at least one symbol on the second bonus playing card indicative of a rank from the standard set of playing card ranks.

13. The method of claim 12 wherein supplying at least a first bonus playing card having a first bonus symbol indicative of a first bonus value includes supplying a first bonus playing card with a first bonus symbol indicative of a first rank, and wherein supplying at least a second bonus playing card having a second bonus symbol indicative of a second bonus value includes supplying a second bonus playing card with a second bonus symbol indicative of the first rank.

14. The method of claim 12, further comprising:
supplying at least a third bonus playing card having a third bonus symbol indicative of a third bonus value, the third bonus symbol different from the first and the second bonus symbols and the third bonus value different from the first and the second bonus values, at least one symbol on the third bonus playing card indicative of a rank from the standard set of playing card ranks.

15. The method of claim 14 wherein supplying at least a first bonus playing card having a first bonus symbol indicative of a first bonus value includes supplying a first bonus playing card with a first bonus symbol indicative of a first rank, wherein supplying at least a second bonus playing card having a second bonus symbol indicative of a second bonus value includes supplying a second bonus playing card with a second bonus symbol indicative of the first rank, and wherein supplying at least a third bonus playing card having a third bonus symbol indicative of a third bonus value includes supplying a third bonus playing card with a third bonus symbol indicative of the first rank.

16. The method of claim 12 wherein supplying a plurality of standard playing cards, each of the standard playing cards having a rank symbol indicative of a rank from a standard set of playing card ranks and a suit symbol indicative of a suit from a standard set of playing card suits includes supplying a plurality of standard playing cards having standard rank symbols selected from the group consisting of 2, 3, 4, 5, 6, 7, 8, 9, 10, J, K, Q, and A, and having standard suit symbols selected from the group consisting of [symbol] , [symbol] , ♡. ♦.

17. The method of claim 1 wherein supplying a plurality of standard playing cards, each of the standard playing cards having a rank symbol indicative of a rank from a standard set of playing card ranks and a suit symbol indicative of a suit from a standard set of playing card suits includes supplying a plurality of standard playing cards having standard rank symbols selected from the group consisting of 2, 3, 4, 5, 6, 8, 9, 10, J, K, Q, and A, and having standard suit symbols selected from the group consisting of [symbol] , [symbol] , ♡, ♦.

18. The method of claim 1, further comprising:
receiving input indicative of a desired theoretical hold for a combination of an underlying card game and a bonus game played with the set of playing cards; and
automatically determining a composition of the set of playing cards based at least in part on the desired theoretical hold.

19. The method of claim 18 wherein automatically determining a composition of the set of playing cards based at least in part on the desired theoretical hold includes automatically determining a total number of the bonus playing cards to supply to the set of playing cards.

20. The method of claim 18 wherein automatically determining a composition of the set of playing cards based at least in part on the desired theoretical hold includes automatically determining a total number of the bonus playing cards of each of at least the first and the second bonus values to supply to the set of playing cards.

21. The method of claim 20, further comprising:
receiving input indicative of a selection with respect to at least one rule of a game to be played with the set of playing cards; and wherein automatically determining the composition of the set of playing cards is based at least in part on the selection with respect to the at least one rule.

22. The method of claim 20, further comprising:
receiving input indicative of whether a push in an underlying card game counts as a loss for a player; and wherein automatically determining the composition of the set of playing cards is based at least in part on the received input indicative of whether a push in an underlying card game counts as a loss for a player.

23. The method of claim 20, further comprising:
receiving input indicative of whether a push with at least one bonus playing card in an underlying card game counts as a loss for a player; and wherein automatically determining the composition of the set of playing cards is based at least in part on the received input indicative of whether a push with at least one bonus playing card in an underlying card game counts as a loss for a player.

24. The method of claim 20, further comprising:
receiving input indicative of an amount of each of a number of wagers to be allocated to a progressive jackpot; and wherein automatically determining the composition of the set of playing cards is based at least in part on the amount of each of the wagers to be allocated to the progressive jackpot.

25. The method of claim 20, further comprising:
receiving input indicative of a starting amount of a progressive jackpot;
and wherein automatically determining the composition of the set of playing cards is based at least in part on the starting amount of the progressive jackpot.

26. The method of claim 12, further comprising:
packaging the set of playing cards.

27. A set of playing cards, comprising:
a plurality of standard playing cards, each of the standard playing cards having a respective standard rank symbol and a standard suit symbol;
a plurality of bonus playing cards, each of the bonus playing cards having a respective rank, the ranks of the plurality of bonus playing cards being equal to at least one of a set of standard ranks, where at least two of the bonus playing cards have different bonus values with respect to forming a bonus combination under the rules of a game played with the set of playing cards.

28. The set of playing cards of claim 27 wherein the standard rank symbols of the standard playing cards are selected from the group consisting of 2, 3, 4, 5, 6, 7, 8, 9, 10, J, K, Q, and A, and wherein the standard suit symbols of the standard playing cards are selected from the group consisting of [symbol] , [symbol] , ♡, ♦.

29. The set of playing cards of claim 27 wherein the standard rank symbols of the standard playing cards are selected from the group consisting of 2, 3, 4, 5, 6, 8, 9, 10, J, K, Q, and A, and wherein the standard suit symbols of the standard playing cards are selected from the group consisting of [symbol] , [symbol] , ♡, ♦.

30. The set of playing cards of claim 29 wherein the bonus playing cards each have a rank equal to 7.

31. The set of playing cards of claim 30 wherein the plurality of standard playing cards each have a rank not equal to 7.

32. The set of playing cards of claim 30 wherein the bonus playing cards each have a bonus rank symbol selected from the group consisting of 7, 77, and 777.

33. The set of playing cards of claim 27 wherein the bonus playing cards each have a rank equal to 7.

34. The set of playing cards of claim 33 wherein the bonus playing cards each have a bonus rank symbol selected from the group consisting of 7, 77, and 777.

35. The set of playing cards of claim 27 wherein the bonus playing cards each have a respective bonus value associated therewith, the bonus values selected from at least a first bonus value, a second bonus value and a third bonus value, and where a combination of three bonus playing cards each having a first one of the bonus values is paid a jackpot amount.

36. The set of playing cards of claim 35 wherein the jackpot amount is a progressive jackpot amount.

37. The set of playing cards of claim 36 wherein a combination of playing cards including at least one bonus playing card of the first bonus value and at least one bonus playing card of either the second or the third bonus values is paid at a first set of payout odds under the rules of the game, unless paid the jackpot amount.

38. The set of playing cards of claim 37 wherein a combination of playing cards including at least one bonus playing card of the second bonus value and at least one bonus playing card of any of the first, the second or the third bonus values is paid at the first set of payout odds under the rules of the game, unless paid the jackpot amount.

39. The set of playing cards of claim 38 wherein a combination of playing cards including at least one bonus playing card of the third bonus value and at least two bonus playing cards of any of the first, the second or the third bonus values is paid at the first set of payout odds under the rules of the game, unless paid the jackpot amount.

40. The set of playing cards of claim 39 wherein a combination of playing cards including only a single one of the bonus playing cards of any of the first, the second or the third bonus values, in addition to the standard playing cards, if any, is paid at a second set of payout odds under the rules of the game, unless paid the jackpot amount or paid at the first set of payout odds, the second set of payout odds different from the first set of payout odds.

41. The set of playing cards of claim 40 wherein a combination of playing cards including only a pair of the bonus playing cards of any of the first, the second or the third bonus values, in addition to the standard playing cards, if any, is paid at the second set of payout odds under the rules of the game, unless paid the jackpot amount or paid at the first set of payout odds.

42. The set of playing cards of claim 41 wherein a combination of playing cards including three of a kind of the bonus playing cards of the second or the third bonus values, in addition to the standard playing cards, if any, is paid at the second set of payout odds under the rules of the game, unless paid the jackpot amount or paid at the first set of payout odds.

43. The set of playing cards of claim 27 wherein the set of playing cards includes over 52 of the standard and the bonus playing cards.

44. The set of playing cards of claim 27 wherein the set of playing cards includes an integer multiple of 52 of the standard and the bonus playing cards.

45. A method of operating a card game played with a set of playing cards that includes a plurality of standard playing cards and a plurality of bonus playing cards, each of the standard playing cards having a respective standard rank symbol and a standard suit symbol, each of the bonus playing cards having a respective rank, the ranks of the plurality of bonus playing cards being equal to at least one of a set of standard ranks, where at least two of the bonus playing cards have different bonus values with respect to forming a bonus combination under the rules of a game played with the set of playing cards, the method comprising:
for any winning hands under a set of rules of an underlying card game, paying a standard payout amount based on a standard payout schedule for the underlying card game; and
for any winning hands under the set of rules of the underlying card game that contain at least one bonus playing card, paying a bonus amount based on a bonus payout schedule.

46. The method of claim 45, further comprising:
for any losing hands, collecting a wagered amount.

47. The method of claim 45 wherein the bonus playing cards each have a respective bonus value selected from at least three bonus values and wherein paying a bonus amount includes paying a winning hand including a bonus combination of three bonus playing cards each having a first one of the bonus values a jackpot amount.

48. The method of claim 47 wherein paying a jackpot amount includes paying a progressive jackpot amount.

49. The method of claim 47 wherein paying a bonus amount includes paying a bonus combination of playing cards including at least one bonus playing card of the first bonus value and at least one bonus playing card of either the second or the third bonus values at a first set of payout odds, unless the bonus combination is paid the jackpot amount.

50. The method of claim 49 wherein paying a bonus amount includes paying a bonus combination of playing cards including at least one bonus playing card of the second bonus value and at least one bonus playing card of any of the first, the second or the third bonus values at the first set of payout odds, unless the bonus combination is paid the jackpot amount.

51. The method of claim 50 wherein paying a bonus amount includes paying a bonus combination of playing cards including at least one bonus playing card of the third bonus value and at least two bonus playing cards of any of the first, the second or the third bonus values at the first set of payout odds, unless the bonus combination is paid the jackpot amount.

52. The method of claim 51 wherein paying a bonus amount includes paying a bonus combination of playing cards including only a single one of the bonus playing cards of any of the first, the second or the third bonus values, in addition to the standard playing cards, if any, at a second set of payout odds, unless the bonus combination is paid the jackpot amount or paid at the first set of payout odds, the second set of payout odds different from the first set of payout odds.

53. The method of claim 52 wherein paying a bonus amount includes paying a bonus combination of playing cards including only a pair of the bonus playing cards of any of the first, the second or the third bonus values, in addition to the standard playing cards, if any, at the second set of payout odds, unless the bonus combination is paid the jackpot amount or paid at the first set of payout odds.

54. The method of claim 53 wherein paying a bonus amount includes paying a bonus combination of playing cards including three of a kind of the bonus playing cards of the second or the third bonus values, in addition to the standard playing cards, if any, at the second set of payout odds, unless paid the jackpot amount or paid at the first set of payout odds.

55. The method of claim 45 wherein paying a bonus amount includes paying a winning hand that includes a bonus combination of bonus playing cards a jackpot amount upon an occurrence of an independent event.

56. The method of claim 55 wherein paying a winning hand that includes a combination of bonus playing cards a jackpot amount upon an occurrence of an independent event includes paying the winning hand that includes a combination of bonus playing cards upon the occurrence of a random event.

57. The method of claim 55 wherein paying a winning hand that includes a combination of bonus playing cards a jackpot amount upon an occurrence of an independent event includes paying the winning hand that includes a combination of bonus playing cards upon the occurrence of a first of a random event and a termination of a time period.

58. The method of claim 45 wherein paying a standard payout amount includes paying a standard payout amount based on the rules of blackjack.

59. The method of claim 45 wherein paying a standard payout amount includes paying a standard payout amount based on the rules of baccarat.

60. The method of claim 45 wherein paying a standard payout amount includes paying a standard payout amount based on the rules of at least one of poker, PIA GOW poker, or CARIBBEAN stud poker.

61. The method of claim 45, further comprising:
allocating a portion of each of a number of wagers placed on an underlying card game to a progressive jackpot.

62. The method of claim 45, further comprising:
automatically determining an amount of each of a number of wagers;
automatically allocating a portion of each of the wagers to a progressive jackpot.

63. The method of claim 45, further comprising:
displaying the amount of the progressive jackpot to patrons.

64. The method of claim 45, further comprising:
determining whether a player's hand beats a dealer's hand based on a set of rules of an underlying card game.

65. The method of claim 64 wherein determining whether a player's hand beats a dealer's hand is based on the rules of blackjack.

66. The method of claim 45, further comprising:
determining whether a player's hand beats a banker's hand based on the rules of baccarat.

67. The method of claim 45, further comprising:
determining whether a player's hand beats another hand based on the rules of at least one of poker, PIA GOW poker, or CARIBBEAN stud poker.

68. A system of operating a card game played with a set of playing cards that includes a plurality of standard playing cards, each of the standard playing cards having a respective standard rank symbol and standard suit symbol and a plurality of bonus playing cards, each of the bonus playing cards having a respective rank, the ranks of the plurality of bonus playing cards being equal to at least one of a set of standard ranks, where at least two of the bonus playing cards have different bonus values with respect to forming a bonus combination under the rules of a game played with the set of playing cards, the system comprising:
a wager recognition subsystem that automatically identifies an amount of each of a respective wager placed by each of a number of players;
a wager allocation subsystem that automatically allocates a portion of the wager placed by each of the players to a bonus jackpot pool;
a bonus event subsystem that automatically determines when a bonus event occurs; and
a bonus jackpot award subsystem that awards the bonus jackpot pool to a player having a winning hand that includes a first number of a first type of bonus playing card when the bonus event occurs.

69. The system of claim 68 wherein the wager recognition subsystem includes at least one electromagnetic sensor that senses information indicative of an amount of a number of chips at a location at least proximate at least one wager placement areas.

70. The system of claim 68 wherein the bonus event subsystem is configured to determine the occurrence of a random event.

71. The system of claim 68 wherein the bonus event subsystem is configured to determine the occurrence of a first one of a random event and a termination of a time period.

72. The system of claim 68 wherein the bonus jackpot award subsystem is configured to produce a hand containing a first number of a first type of bonus playing card when the bonus event occurs.

73. The system of claim 68, further comprising:
at least one display subsystem configured to display a current amount of the bonus jackpot pool.
